(19) United States
(12) Patent Application Publication
(10) Pub. No.: US 2025/0317375 A1
(43) Pub. Date: Oct. 9, 2025

(54) MITIGATING ASYMMETRIC LATENCY OF A COMMUNICATION LINK

(71) Applicant: Marvell Asia Pte Ltd, Singapore (SG)

(72) Inventors: Whay Sing LEE, Milpitas, CA (US); Rajesh EDAMULA, Saratoga, CA (US)

(21) Appl. No.: 19/170,956

(22) Filed: Apr. 4, 2025

Related U.S. Application Data
(60) Provisional application No. 63/575,611, filed on Apr. 5, 2024.

(51) Int. Cl. H04L 43/0852; H04L 43/12; H04L 47/12

(52) U.S. Cl. CPC H04L 43/0852; H04L 43/12; H04L 47/12

(57) ABSTRACT

To improve time synchronization in a communication network, a first communication device generates a measurement of a first latency of a transmit path of a communication link between the first communication device and a second communication device. The communication link also includes a receive path. The first communication device compensates for an asymmetry between the first latency of the transmit path and a second latency of the receive path using the measurement of the first latency.

### CROSS REFERENCES TO RELATED APPLICATIONS

This application claims the benefit of U.S. Provisional Patent App. No. 63/575,611, entitled “End-to-End Latency Measurement Using ANLT Extension,” filed on Apr. 5, 2024, the disclosure of which is incorporated herein by reference in its entirety for all purposes.

### FIELD OF TECHNOLOGY

This disclosure relates generally to network communications, and more particularly to techniques for mitigating asymmetric latency in a communication system.

### BACKGROUND

The approaches described in this background section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Clock synchronization protocols are commonly used in packet-based networks to synchronize clocks maintained at different network devices. In such clock synchronization protocols, a first network device, which maintains a master clock, otherwise referred to herein as a source clock, transmits a timing packet including a transmit timestamp generated based on a source clock time to a second network device, which maintains a slave clock, otherwise referred to herein as an endpoint clock. The second network device utilizes the transmit timestamp of the timing packet and an estimated network latency to adjust the endpoint clock in order to synchronize the endpoint clock with the source clock.

The Precision Time Protocol (PTP) is a network-based time synchronization standard that provides sub-microsecond-level synchronization. For some commercial and industrial applications, time synchronization with high accuracy is crucial, and the PTP is widely used for achieving such accuracy. For example, some applications implemented in a data center environment require multiple compute nodes to operate synchronously. In a data center, a precise, standardized time value is communicated throughout compute nodes in the data center, which permits coordinated, time-synchronized actions to be performed by the compute nodes.

As another example, the fifth generation (5G) wireless communication standard requires highly accurate timing and synchronization. In a 5G wireless communication network, a precise, standardized time value is communicated throughout the network, which permits coordinated, time-synchronized network actions, such as coordinated transmissions, cell-to-cell transfers, compensation for frequency and/or phase shifts, etc.

Different applications require different levels of clock accuracy. For telecommunication applications, the International Telecommunications Union (ITU) standard G.8273.2 defines different classes, A, B, C, and D, generally corresponding to different levels of accuracy requirements, with class D being the highest accuracy requirement. For 5G applications, class C is a mandatory requirement.

### SUMMARY

In an embodiment, a network device is configured to operate in a communication network. The network device comprises: transmit circuitry configured to couple with a transmit path of a communication link; receive circuitry configured to couple with a receive path of the communication link, the receive circuitry comprising decoding circuitry configured to decode data units received by the receive circuitry; latency measurement circuitry coupled to the transmit path, the latency measurement circuitry configured to generate a measurement of a first latency of the transmit path; and latency compensation circuitry communicatively coupled to one or both of the transmit circuitry and the receive circuitry, the latency compensation circuitry configured to compensate for an asymmetry between the first latency of the transmit path and a second latency of the receive path using at least the measurement of the first latency.

In another embodiment, a method for improving time synchronization in a communication network includes: generating, at the first communication device, a measurement of a first latency of a transmit path of a communication link between the first communication device and a second communication device, the communication link also including a receive path; and compensating, by the first communication device, for an asymmetry between the first latency of the transmit path and a second latency of the receive path using the measurement of the first latency.

In another embodiment, a communication system comprises a first network device coupled to a communication link. The first network device includes: first transmit circuitry coupled to a first path of the communication link and first receive circuitry coupled to a second path of the communication link. The communication system also comprises a second network device coupled to the communication link. The second network device includes: second transmit circuitry coupled to the second path of the communication link and second receive circuitry coupled to the first path of the communication link. The first network device further comprises: first latency measurement circuitry coupled to the first path, the first latency measurement circuitry configured to generate a measurement a first latency of the first path, and first latency compensation circuitry communicatively coupled to one or both of the first transmit circuitry and the first receive circuitry, the first latency compensation circuitry configured to compensate for an asymmetry between the first latency of the first path and a second latency of the second path using the measurement of the first latency. The second network device further comprises: second latency measurement circuitry coupled to the second path, the second latency measurement circuitry configured to generate a measurement of the second latency of the second path, and second latency compensation circuitry communicatively coupled to one or both of the second transmit circuitry and the second receive circuitry, the second latency compensation circuitry configured to compensate for asymmetry between the first latency of the first path and the second latency of the second path using the measurement of the second latency.

### BRIEF DESCRIPTION OF THE DRAWINGS

FIG. 1 is a simplified block diagram of an example communication system that measures and/or mitigates an asymmetry between latencies of a communication link, according to an embodiment.

FIG. 2 is a simplified block diagram of example circuitry of a communication device in the communication system of FIG. 1, the circuitry being configured to i) measure a physical channel latency of a path corresponding to a communication link, and ii) use the measured physical channel latency to mitigate asymmetric latencies of the communication link, according to an embodiment.

FIG. 3 is a simplified diagram of a portion of a communication device that includes the circuitry of FIG. 2, according to an embodiment.

FIG. 4 is a diagram of a simplified model of logical channel latencies in the communication system of FIG. 1, according to an embodiment.

FIG. 5 is a simplified diagram of example physical channel latency measurement circuitry of a communication device in the communication system of FIG. 1, according to an embodiment.

FIG. 6 is a simplified state transition diagram illustrating an example auto-negotiation and link training (ANLT) procedure in which latency measurements and an adjustment to a logical channel latency are performed to mitigate logical channel latency asymmetry, according to an embodiment.

FIG. 7 is a simplified block diagram of another example communication system that measures and/or mitigates an asymmetry between latencies of a communication link, according to another embodiment.

FIG. 8 is a flow diagram of an example method for improving time synchronization in a communication network, according to an embodiment.

FIG. 9 is a flow diagram of an example method for measuring latency of a communication link in a communication network, according to another embodiment.

### DETAILED DESCRIPTION

As discussed above, clock synchronization protocols like the Precision Time Protocol (PTP) are commonly used in communication networks to synchronize clocks of network devices. In PTP, a leader device that maintains a leader clock periodically broadcasts “sync” messages, where each sync message includes a current time of the leader clock. Follower devices receive the sync messages and use the current time in each sync message to synchronize their follower clocks to the leader clock.

There is a transit time delay between when the leader device transmits the sync message and when a follower device receives the sync message, and thus the current time in each sync message is out of date when received at the follower device. Therefore, PTP provides a mechanism for measuring the transit time between the leader device and the follower device. In particular, the transit time is determined indirectly by measuring a round-trip time from the follower device to the leader device. Measuring the round-trip time involves i) the leader device transmitting a first message at time T1 (as measured by the leader clock, which the follower device receives at time T2 (as measured by the follower clock); and ii) the follower device transmitting a second message at time T3 (as measured by the follower clock, which the leader device receives at time T4 (as measured by the leader clock).

The first message includes the value of T1, and the leader device transmits to the follower device a third message that includes the value of T4. Therefore, the follower device is aware of T1, T2, T3, and T4. Assuming that a transit time d between the leader device and the follower device is symmetric (i.e., a first transit time d1 from the follower device to the leader device is equal to a second transit time d2 from the leader device to the follower device), then:

$$T 2 - T 1 = offset + d \qquad Equation 1$$

$$T 4 - T 3 = offset + d \qquad Equation 2$$

where offset is an assumed constant offset between the leader clock and the follower clock. Combining Equation 1 and Equation 2, the offset can be determined as:

$$offset = 1 / 2 ⋆ ( T 2 - T 1 - T 4 + T 3 ) \qquad Equation 3$$

Thus, the follower device can calculate offset using the values of T1, T2, T3, and T4, and use offset to adjust the follower clock to match the leader clock.

As discussed above, the clock synchronization mechanism of PTP assumes that the transit delay d between a leader device and a follower device is symmetrical. In practice, however, the first transit time d1 from the follower device to the leader device is different than the second transit time d2 from the leader device to the follower device because a first path from a transmitter of the leader device to a receiver of the follower device is different than a second path from a transmitter of the follower device to a receiver of the leader device. For instance, in an Ethernet communication system that communicates via an electrical cable, a transmitter and a receiver of a communication device are typically implemented on an integrated circuit (IC) chip, and a first length of a first trace on the IC chip from the transmitter to a first pin of the IC chip is often different than a second length of a second trace on the IC chip from the receiver to a second pin of the IC chip. Additionally, a third length of a third trace on a printed circuit board (PCB) from the first pin of the IC chip to a cable connector is often different than a fourth length of a fourth trace on the PCB from the second pin of the IC chip to the cable connector.

For some applications that do not require high clock synchronization accuracy, an asymmetry between a transmit path and a receive path does not adversely affect performance, and thus the assumption (e.g., by PTP) of symmetry between the transmit path and the receive path is acceptable for such applications. On the other hand, for applications that require relatively high clock synchronization accuracy, the asymmetry between the transmit path and the receive path may adversely affect performance.

In embodiments described below, a communication system measures an asymmetry between i) a first latency corresponding to a first communication path from a first communication device to a second communication device, and ii) a second latency corresponding to a second communication path from the second communication device to the first communication device; and/or the communication system mitigates the asymmetry to improve clock synchronization, for example.

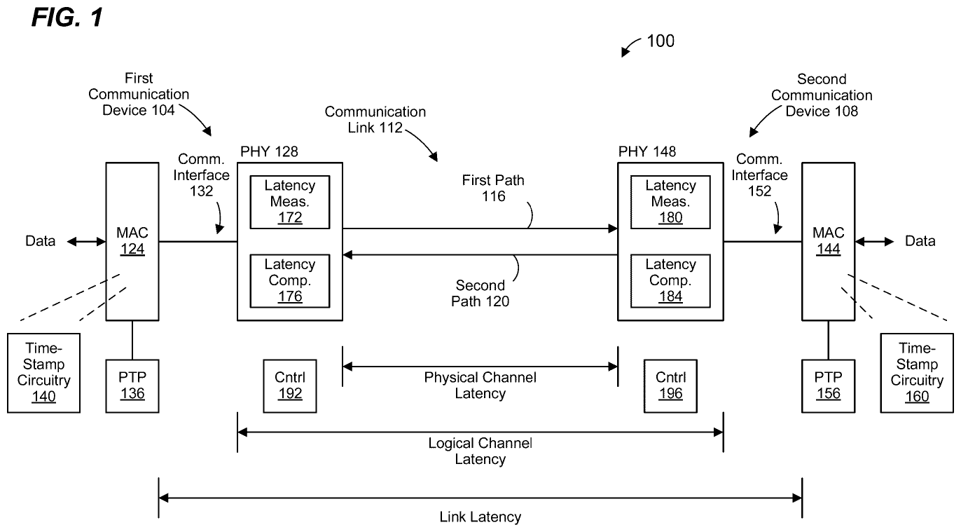

FIG. 1 is a simplified block diagram of an example communication system 100 that measures and/or mitigates an asymmetry between i) a first latency corresponding to a first communication path from a first communication device 104 to a second communication device 108, and ii) a second latency corresponding to a second communication path from the second communication device 108 to the first communication device 104, according to an embodiment. Measuring and/or mitigating the asymmetry between the first latency and the second latency facilitates more accurate clock synchronization as compared to conventional communication systems, according to some embodiments. Some elements of the first communication device 104 and the second communication device 108 are not illustrated in FIG. 1 to avoid obscuring the techniques described herein.

The first communication device 104 and the second communication device 108 are communicatively coupled via a communication link 112. The communication link 112 comprises a communication medium such as an electrical cable (e.g., a cable having one or more twisted wire pairs, a coaxial cable, etc.), an optical cable, free space, etc., according to various embodiments. The communication link 112 also comprises components of the first communication device 104 and the second communication device 108, such as traces in an IC chip, traces in a PCB on which the IC chip is mounted, etc.

The communication link 112 comprises a first path 116 in a first direction from the first communication device 104 to the second communication device 108, and a second path 120 in a second direction from the second communication device 108 to the first communication device 104. The first path 116 (which is sometimes referred to herein as a “transmit path” from the standpoint of the first communication device 104) has a first length that is different than a second length of the second path 120 (which is sometimes referred to herein as a “receive path” from the standpoint of the first communication device 104). As a result, a first transit latency of the first path 116 is different than a second transit latency of the second path 120, i.e., the transit latencies of the communication link 112 are asymmetric.

The first communication device 104 includes a media access control layer (MAC) processor 124 coupled to a physical layer (PHY) processor 128 via a communication interface 132. The communication interface 132 is a suitable media independent interface (MII), in an embodiment. In other embodiments, the communication interface 132 is another suitable communication interface, such as a serial interface.

The MAC processor 124 is configured to i) receive packets from the PHY processor 128 via the communication interface 132, ii) perform MAC operations with respect to the packets received from the PHY processor 128, e.g., to parse and de-capsulate the packets, and iii) output the packets for processing by another processor, such as a host processor (not shown) for further processing, in an embodiment. The MAC processor 124 is also configured to i) receive messages from another processor, such as a host processor (not shown), ii) perform MAC operations with respect to the messages received from the other processor, e.g., to encapsulate the messages with one or more protocol headers to generate packets, and iii) transfer the packets via the communication interface 132 to the PHY processor 128 for transmission via the communication link 112, in an embodiment.

The PHY processor 128 is configured to i) receive packet data from the MAC processor 124 via the communication interface 132, ii) generate a transmit signal corresponding to the packet data, and iii) transmit the signal via the communication link 112, in an embodiment. Similarly, the PHY processor 128 is configured to i) receive a signal from the communication link 112, ii) decode packet data from the receive signal, and then iii) transfer the packet data to the MAC processor 124 via the communication interface 132.

A PTP controller 136 is communicatively coupled to the MAC processor 124. The PTP controller 136 is configured to i) generate PTP messages, such as PTP sync messages, PTP Delay_Req messages, PTP Delay_Resp messages, etc., defined by the PTP, and ii) provide the PTP messages to the MAC processor 124. The MAC processor 124 receives the PTP messages from the PTP controller 136, performs MAC operations with respect to the PTP messages, e.g., to encapsulate the PTP messages with one or more protocol headers to generate packets, and iii) transfers the packets via the communication interface 132 to the PHY processor 128 for transmission via the communication link 112, in an embodiment.

Additionally, the PTP controller 136 is configured to receive PTP messages from the MAC processor 124, the PTP messages from the MAC processor 124 having been transmitted by the second communication device 108 via the communication link 112.

The PTP controller 136 comprises a processor (not shown) that executes machine-readable instructions stored in a memory (not shown) coupled to the processor, where the machine readable instructions, when executed by the processor, cause the processor to perform operations corresponding to PTP such as generating PTP messages, sending PTP messages to MAC processor 124 for transmission via the communication link, analyzing PTP messages received from the second communication device 108 via the communication link 112, etc., in an embodiment. In another embodiment, the PTP controller 136 additionally or alternatively comprises a hardware state machine (not shown) that is configured to perform operations corresponding to PTP such as generating PTP messages, sending PTP messages to MAC processor 124 for transmission via the communication link, analyzing PTP messages received from the second communication device 108 via the communication link 112, etc.

The MAC processor 124 includes timestamping circuitry 140, and the MAC processor 124 controls the timestamping circuitry 140 to add timestamps to at least some PTP messages from the PTP controller 136 that are being transferred to the PHY processor 128, in an embodiment, the timestamps indicating when the PTP messages are being transmitted by the first communication device 104. In some embodiments, the MAC processor 124 controls the timestamping circuitry 140 to add timestamps to PTP messages received from the PHY processor 128, in an embodiment, the timestamps indicating when the PTP messages were received by the first communication device 104. In some embodiments, the PTP controller 136 includes additional timestamping circuitry (not shown) that adds timestamps to at least some PTP messages, and the timestamping circuitry 140 of the MAC processor 124 i) modifies the timestamps added by the PTP controller 136 to improve accuracy of the timestamps, and/or ii) adds timing information to the PTP messages to improve accuracy of the timestamps added by the PTP controller 136.

In other embodiments, the timestamping circuitry 140 is omitted from the MAC processor 124. In some embodiments, the PHY processor 128 includes timestamping circuitry (not shown); the PHY processor 128 controls the timestamping circuitry to add timestamps to at least some PTP messages from the PTP controller 136, in an embodiment, the timestamps indicating when the PTP messages are being transmitted by the first communication device 104; and the PHY processor 128 controls the timestamping circuitry (not shown) to add timestamps to PTP messages received via the communication link 112, the timestamps indicating when the PTP messages were received by the first communication device 104. In an embodiment in which the PHY processor 128 includes timestamping circuitry (not shown) and the PTP controller 136 includes additional timestamping circuitry (not shown), the additional timestamping circuitry of the PTP controller 136 adds timestamps to at least some PTP messages, and the timestamping circuitry of the PHY processor 128 i) modifies the timestamps added by the PTP controller 136 to improve accuracy of the timestamps, and/or ii) adds timing information to the PTP messages to improve accuracy of the timestamps.

The second communication device 108 has a structure the same as or similar to the first communication device 104. For example, the second communication device 108 includes a MAC processor 144 communicatively coupled to a PHY processor 128 via a communication interface 152. The MAC processor 144 has a structure the same as or similar to the MAC processor 124, and/or the PHY processor 148 has a structure the same as or similar to the PHY processor 128, in an embodiment. In another embodiment, the MAC processor 144 has a suitable structure different than the MAC processor 124, and/or the PHY processor 148 has a suitable structure different than the PHY processor 128.

The communication interface 152 is a suitable MII, in an embodiment. In other embodiments, the communication interface 152 is another suitable communication interface, such as a serial interface.

The MAC processor 144 is configured to i) receive packets from the PHY processor 148 via the communication interface 152, ii) perform MAC operations with respect to the packets received from the PHY processor 148, e.g., to parse and de-capsulate the packets, and iii) output the packets form processing by another processor, such as a host processor (not shown) for further processing, in an embodiment. The MAC processor 144 is also configured to i) receive messages from another processor, such as a host processor (not shown), ii) perform MAC operations with respect to the messages received from the other processor, e.g., to encapsulate the messages with one or more protocol headers to generate packets, and iii) transfer the packets via the communication interface 152 to the PHY processor 148 for transmission via the communication link 112, in an embodiment.

The PHY processor 148 is configured to i) receive packet data from the MAC processor 144 via the communication interface 152, ii) generate a transmit signal corresponding to the packet data, and iii) transmit the signal via the communication link 112, in an embodiment. Similarly, the PHY processor 148 is configured to i) receive a signal from the communication link 112, ii) decode packet data from the receive signal, and then iii) transfer the packet data to the MAC processor 144 via the communication interface 152.

A PTP controller 156 is communicatively coupled to the MAC processor 144. The PTP controller 156 is configured to generate PTP messages, such as PTP sync messages, PTP Delay_Req messages, PTP Delay_Resp messages, etc., and provide the PTP messages to the MAC processor 144. The MAC processor 144 receives the PTP messages from the PTP controller 156, performs MAC operations with respect to the PTP messages, e.g., to encapsulate the PTP messages with one or more protocol headers to generate packets, and iii) transfers the packets via the communication interface 152 to the PHY processor 148 for transmission via the communication link 112, in an embodiment.

Additionally, the PTP controller 156 is configured to receive PTP messages from the MAC processor 144, the PTP messages from the MAC processor 144 having been transmitted by the second communication device 108 via the communication link 112.

The PTP controller 156 comprises a processor (not shown) that executes machine-readable instructions stored in a memory (not shown) coupled to the processor, where the machine readable instructions, when executed by the processor, cause the processor to perform operations corresponding to PTP such as generating PTP messages, sending PTP messages to MAC processor 144 for transmission via the communication link 112, analyzing PTP messages received from the first communication device 104 via the communication link 112, etc., in an embodiment. In another embodiment, the PTP controller 156 additionally or alternatively comprises a hardware state machine (not shown) that is configured to perform operations corresponding to PTP such as generating PTP messages, sending PTP messages to MAC processor 144 for transmission via the communication link 112, analyzing PTP messages received from the first communication device 104 via the communication link 112, etc.

The MAC processor 144 includes timestamping circuitry 160, and the MAC processor 144 controls the timestamping circuitry 160 to add timestamps to at least some PTP messages from the PTP controller 156 that are being transferred to the PHY processor 148, in an embodiment, the timestamps indicating when the PTP messages are being transmitted by the second communication device 108. In some embodiments, the MAC processor 144 controls the timestamping circuitry 160 to add timestamps to PTP messages received from the PHY processor 148, in an embodiment, the timestamps indicating when the PTP messages were received by the second communication device 108. In some embodiments, the PTP controller 156 includes additional timestamping circuitry (not shown) that adds timestamps to at least some PTP messages, and the timestamping circuitry 160 of the MAC processor 144 i) modifies the timestamps added by the PTP controller 156 to improve accuracy of the timestamps, and/or ii) adds timing information to the PTP messages to improve accuracy of the timestamps added by the PTP controller 156.

In other embodiments, the timestamping circuitry 160 is omitted from the MAC processor 144. In some embodiments, the PHY processor 148 includes timestamping circuitry (not shown); the PHY processor 148 controls the timestamping circuitry to add timestamps to at least some PTP messages from the PTP controller 156, in an embodiment, the timestamps indicating when the PTP messages are being transmitted by the second communication device 108; and the PHY processor 148 controls the timestamping circuitry (not shown) to add timestamps to PTP messages received via the communication link 112, the timestamps indicating when the PTP messages were received by the second communication device 108. In an embodiment in which the PHY processor 148 includes timestamping circuitry (not shown) and the PTP controller 156 includes additional timestamping circuitry (not shown), the additional timestamping circuitry of the PTP controller 156 adds timestamps to at least some PTP messages, and the timestamping circuitry of the PHY processor 148 i) modifies the timestamps added by the PTP controller 156 to improve accuracy of the timestamps, and/or ii) adds timing information to the PTP messages to improve accuracy of the timestamps.

The first path 116 has a latency corresponding to the first length of the first path 116, and the second path 120 has a latency (sometimes referred to herein as a “second physical channel latency”) corresponding to the second length of the second path 120. The first physical channel latency is different than the second physical channel latency, i.e., the physical channel latencies are asymmetric.

There is a first logical channel latency from when a message (e.g., a PTP message) is received by the PHY processor 128 to when the message is provided by the PHY processor 148 to the communication interface 152; and there is a second logical channel latency from when a message (e.g., a PTP message) is received by the PHY processor 148 to when the message is provided by the PHY processor 128 to the communication interface 132. The first logical channel latency includes the first physical channel latency, and the second logical channel latency includes the second physical channel latency. Thus, at least because the physical channel latencies are asymmetric, the logical channel latencies are asymmetric, in an embodiment.

There is a first link latency from when a message (e.g., a PTP message) is received by the MAC processor 124 to when the message is output by the MAC processor 144; and there is a second link latency from when a message (e.g., a PTP message) is received by the MAC processor 144 to when the message is output by the MAC processor 124. The first link latency includes the first logical channel latency, which includes the first physical channel latency, and the second link latency includes the second logical channel latency, which includes the second physical channel latency. Thus, at least because the logical channel latencies are asymmetric, the link latencies are asymmetric, in an embodiment.

The PHY processor 128 includes latency measurement circuitry 172 that is configured to measure the first physical channel latency of the first path 116. As will described further below, in an embodiment, the latency measurement circuitry 172 is configured to i) transmit a probe signal (e.g., an impulse signal, a pulse, etc.) in the first path 116, ii) detect a reflection of the probe signal in the first path 116, and iii) use the detected reflection to determine the first physical channel latency of the first path 116. In other embodiments, the latency measurement circuitry 172 measures the first physical channel latency of the first path 116 in another suitable manner.

In another embodiment, the latency measurement circuitry 172 is also configured to measure an additional component of the first logical channel latency from when a message (e.g., a PTP message) is received by the PHY processor 128 to when the message is provided by the PHY processor 148 to the communication interface 152, where the additional component is distinct from the first physical channel latency.

In another embodiment, the latency measurement circuitry 172 is additionally or alternatively configured to measure a component of the second logical channel latency from when a message (e.g., a PTP message) is received by the PHY processor 148 to when the message is provided by the PHY processor 128 to the communication interface 132, where the component is distinct from the second physical channel latency.

Latency compensation circuitry 176 is configured to use the measured first physical channel latency (and optionally one or both of i) the measured additional component of the first logical channel latency and ii) the measured component of the second logical channel latency) to adjust one or both of the first logical channel latency and the second logical channel latency to mitigate the logical channel latency asymmetry (e.g., to make the first logical channel latency approximately equal to the second logical channel latency). As will be described further below, the latency compensation circuitry 176 includes one or both of i) first configurable delay circuitry corresponding to the first logical channel and ii) second configurable delay circuitry corresponding to the second logical channel, and the latency compensation circuitry 176 adjusts one or both of i) the first configurable delay circuitry corresponding to the first logical channel and ii) the second configurable delay circuitry corresponding to the second logical channel, to mitigate the logical channel latency asymmetry (e.g., to make the first logical channel latency approximately equal to the second logical channel latency), in an embodiment.

Similarly, the PHY processor 148 includes latency measurement circuitry 180 that is configured to measure the second physical channel latency of the second path 120. As will described further below, in an embodiment, the latency measurement circuitry 180 is configured to i) transmit a probe signal (e.g., an impulse signal, a pulse, etc.) in the second path 120, ii) detect a reflection of the probe signal in the second path 120, and iii) use the detected reflection to determine the second physical channel latency of the second path 120. In other embodiments, the latency measurement circuitry 180 measures the second physical channel latency of the second path 120 in another suitable manner.

In another embodiment, the latency measurement circuitry 180 is also configured to measure an additional component of the second logical channel latency from when a message (e.g., a PTP message) is received by the PHY processor 148 to when the message is provided by the PHY processor 128 to the communication interface 132, where the additional component is distinct from the second physical channel latency.

In another embodiment, the latency measurement circuitry 180 is additionally or alternatively configured to measure a component of the first logical channel latency from when a message (e.g., a PTP message) is received by the PHY processor 128 to when the message is provided by the PHY processor 148 to the communication interface 152, where the component is distinct from the first physical channel latency.

Latency compensation circuitry 184 is configured to use the measured second physical channel latency (and optionally one or both of i) the measured additional component of the second logical channel latency and ii) the measured component of the first logical channel latency) to adjust one or both of the first logical channel latency and the second logical channel latency to mitigate the logical channel latency asymmetry (e.g., to make the first logical channel latency approximately equal to the second logical channel latency). As will be described further below, the latency compensation circuitry 184 includes one or both of i) first configurable delay circuitry corresponding to the first logical channel and ii) second configurable delay circuitry corresponding to the second logical channel, and the latency compensation circuitry 184 adjusts one or both of i) the first configurable delay circuitry corresponding to the first logical channel and ii) the second configurable delay circuitry corresponding to the second logical channel, to mitigate the logical channel latency asymmetry (e.g., to make the first logical channel latency approximately equal to the second logical channel latency), in an embodiment.

The first communication device 104 also includes a controller 192 that controls operation of the MAC processor 124 and the PHY processor 128, in an embodiment. In an embodiment, the controller 192 prompts the latency measurement circuitry 172 to measure the first physical channel latency of the first path 116. In another embodiment, the controller 192 additionally prompts the latency measurement circuitry 172 to measure one or both of i) the additional component of the first logical channel latency discussed above, and ii) the component of the second logical channel latency discussed above.

In an embodiment, the controller 192 controls the PHY processor 128 and, optionally, the MAC processor 124 to perform operations corresponding to an auto-negotiation and link training (ANLT) procedure, such as an ANLT procedure for Ethernet defined by the Institute for Electrical and Electronics Engineers (IEEE) 802.3 Standard (IEEE) 802.3 Standard. The IEEE 802.3 Standard defines the ANLT to include two sequential phases: an auto-negotiation phase (AN) followed by a Link Training phase (LT). The AN permits Ethernet devices to exchange capability information with one another in order to agree on a signaling and data encoding mode that both Ethernet devices are capable of using. The LT phase involves exchanging training signals and adjusting parameters of components such as filter coefficients, echo cancellation parameters, cross-talk cancellation parameters, etc.

The ANLT procedure is performed during a procedure for starting up (i.e., bringing up, initializing, etc.) a communication link between communication devices. After the procedure for starting up the communication link is completed, the communication devices transition to a regular data exchange mode of operation in which data is exchanged between the communication devices, e.g., MAC data is exchanged between the communication devices via the communication link.

The controller 192 comprises a processor (not shown) that executes machine-readable instructions stored in a memory (not shown) coupled to the processor, where the machine readable instructions, when executed by the processor, cause the processor to perform operations such as described above, in an embodiment. In another embodiment, the controller 192 additionally or alternatively comprises a hardware state machine (not shown) that is configured to perform operations such as described above.

The second communication device 108 also includes a controller 196 that controls operation of the MAC processor 144 and the PHY processor 148, in an embodiment. In an embodiment, the controller 196 prompts the latency measurement circuitry 180 to measure the second physical channel latency of the first path 120. In another embodiment, the controller 196 additionally prompts the latency measurement circuitry 180 to measure one or both of i) the additional component of the second logical channel latency discussed above, and ii) the component of the first logical channel latency discussed above.

In an embodiment, the controller 196 controls the PHY processor 148 and, optionally, the MAC processor 144 to perform operations corresponding to an ANLT procedure, such as an ANLT procedure for Ethernet defined by the IEEE 802.3 Standard.

The controller 196 comprises a processor (not shown) that executes machine-readable instructions stored in a memory (not shown) coupled to the processor, where the machine readable instructions, when executed by the processor, cause the processor to perform operations such as described above, in an embodiment. In another embodiment, the controller 196 additionally or alternatively comprises a hardware state machine (not shown) that is configured to perform operations such as described above.

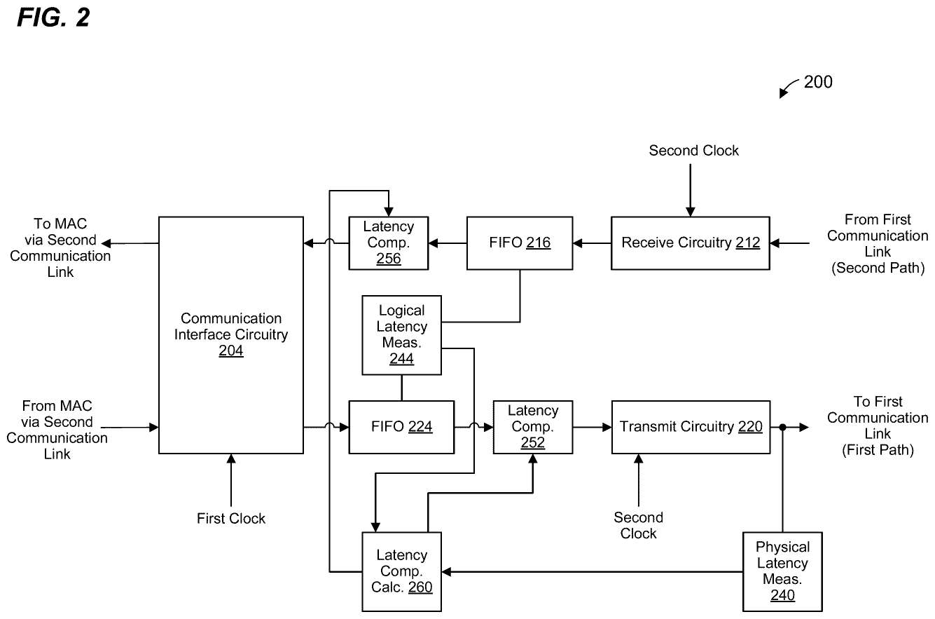

FIG. 2 is a simplified block diagram of an example PHY processor 200 that is configured to i) measure a physical channel latency of a path corresponding to a communication link, and ii) use the measured physical channel latency to mitigate asymmetric latencies of the communication link, according to an embodiment. In an embodiment, the PHY processor 128 (FIG. 1) has a structure the same as or similar to the PHY processor 200. Additionally or alternatively, the PHY processor 148 (FIG. 1) has a structure the same as or similar to the PHY processor 200, in another embodiment. FIG. 2 is described with reference to FIG. 1 for ease of explanation. In other embodiments, the PHY processor 128 and/or the PHY processor 148 have suitable structures different than the PHY processor 200. In other embodiments, the PHY processor 200 is used in a suitable communication system different than the communication system 100 of FIG. 1. Some elements of the PHY processor 200 are not illustrated in FIG. 2 to avoid obscuring the techniques described herein, and the PHY processor 200 includes other elements not illustrated in FIG. 2, in some embodiments.

The PHY processor 200 includes communication interface circuitry 204 configured to transmit packet data to and receive packet data from another processor, such as a MAC processor (e.g., the MAC processor 124). In an embodiment, the communication interface circuitry 204 is coupled to a second communication link (e.g., an MII, a serial communication link, etc.), and the communication interface circuitry 204 operates according to a first clock that is phase-locked to packet data that is received by the communication interface circuitry 204 via the second communication link.

The PHY processor 200 also includes receive circuitry 212 that is configured to receive a receive signal via the first communication link and convert the receive signal into first data bits. For example, the receive circuitry 212 is included in the PHY processor 128 and receives a receive signal via the communication link 112, and converts the receive signal to first data bits.

The receive circuitry 212 includes various components not illustrated in FIG. 2 to avoid obscuring the techniques described herein. For example, the receive circuitry 212 includes signal processing circuitry having one or more of i) decoding circuitry (e.g., slicer circuitry) configured to decode transmit symbols in the receive signal into data bits, ii) one or more signal processing filters, iii) echo cancellation circuitry configured to reduce echoes of a transmit signal in the receive signal, iv) crosstalk cancellation circuitry configured reduce crosstalk in the receive signal caused by other transmit signals, v) an amplifier, etc., according to various embodiments. As another example, the receive circuitry 212 includes serial-to-parallel conversion circuitry configured to convert serial data received via the first communication link 212 to a parallel data stream, according to an embodiment.

In an embodiment, the receive circuitry 212 operates according to a second clock that is phase-locked to packet data that is received by the receive circuitry 212 via the first communication link. In an embodiment, the first clock is frequency-locked to the second clock, but the first clock is not please-locked to the second clock.

The receive circuitry 212 is communicatively coupled to the communication interface circuitry 204 via a first-in-first-out (FIFO) buffer 216. First packet data output by the receive circuitry 212 is written into the FIFO buffer 216 using the second clock, and the first packet data is read from the FIFO buffer 216 using the first clock, in an embodiment. Thus, the FIFO buffer 216 is a mechanism for transferring first packet data from the receive circuitry 212, which operates according to the second clock, to the communication interface circuitry 204, which operates according to the first clock, in an embodiment.

The PHY processor 200 also includes transmit circuitry 220 that is configured to receive second data bits from the communication interface circuitry 204 and generate, based on the second data bits, a transmit signal to be transmitted via the first communication link. For example, the transmit circuitry 220 is included in the PHY processor 128 and generates a transmit signal for transmission via the communication link 112 using second data bits received from the MAC processor 124 via the communication interface 132. The transmit circuitry 220 includes one or more of i) one or more signal processing filters, ii) an amplifier, iii) a drive circuit, etc., according to various embodiments.

In an embodiment, the transmit circuitry 220 operates according to the second clock that is phase-locked to packet data that is received by the receive circuitry 212 via the first communication link.

The transmit circuitry 220 is communicatively coupled to the communication interface circuitry 204 via a FIFO buffer 224. Second packet data output by the communication interface circuitry 204 is written into the FIFO buffer 224 using the first clock, and the second packet data is read from the FIFO buffer 224 using the second clock, in an embodiment. Thus, the FIFO buffer 224 is a mechanism for transferring second packet data from the communication interface circuitry 204, which operates according to the first clock, to the transmit circuitry 220, which operates according to the second clock, in an embodiment.

The PHY processor 200 also includes physical channel latency measurement circuitry 240 that is configured to measure the first physical channel latency of the first path. As will described further below, in an embodiment, the physical channel latency measurement circuitry 240 is configured to i) transmit a probe signal (e.g., an impulse signal, a pulse, etc.) in the first path, ii) detect a reflection of the probe signal in the first path, and iii) use the detected reflection to determine the first physical channel latency of the first path. In other embodiments, the physical channel latency measurement circuitry 240 measures the first physical channel latency of the first path in another suitable manner.

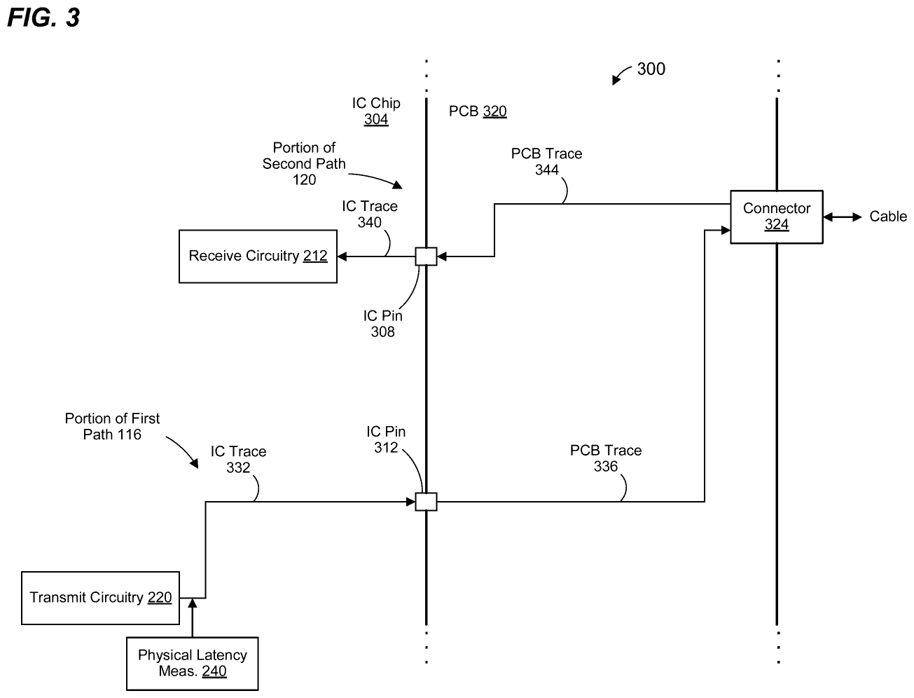

FIG. 3 is a simplified diagram of a portion of a communication device 300, which includes the PHY processor 200 of FIG. 2, according to an embodiment. The communication device 300 comprises an IC chip 304 that includes the PHY processor 200, although only the receiver circuitry 212, the transmit circuitry 220, and the physical channel latency measurement circuitry 240 are illustrated in FIG. 3.

The IC chip 304 is included in an IC chip package that includes a plurality of IC pins, including IC pins 308 and 312. In other embodiments, the IC chip package uses other suitable IC chip connectors other than IC pins, such as solder balls of a ball grid array (BGA), etc.

The IC chip 304 is mounted on a PCB 320. Additionally, a connector 324 is mounted on the PCB 320, the connector 324 configured to communicatively couple to a communication medium. The connector 324 is coupled to a cable or another suitable communication medium. In an embodiment, the connector 324 comprises a cable connector. In another embodiment, the connector 324 comprises a backplane connector. In other embodiments, the connector 324 comprises another suitable connector configured to communicatively couple to a communication medium.

An output of the transmit circuitry 220 is coupled to the IC pin 312 via an IC trace 332 on or in the IC chip 304, and the IC pin 312 is coupled to the connector 324 via a PCB trace 336 on or in the PCB 320. The IC trace 332 and the PCB trace 336 are components of portion of the first path 116.

An input of the receive circuitry 212 is coupled to the IC pin 308 via an IC trace 340 on or in the IC chip 304, and the IC pin 308 is coupled to the connector 324 via a PCB trace 344 on or in the PCB 320. The IC trace 340 and the PCB trace 344 are components of portion of the second path 120.

As illustrated in FIG. 3, the portion of the first path 116 is longer than the portion of the second path 120. Accordingly, latencies of the portion of the first path 116 and the portion of the second path 120 are asymmetric. The physical channel latency measurement circuitry 240 is configured to measure the first physical channel latency of the first path 116, as will be described further below.

Referring again to FIG. 2, logical channel latency measurement circuitry 244 is configured to measure a first latency corresponding to a transmit path in the PHY processor 200 and a second latency corresponding to a receive path in the PHY processor 200, in an embodiment. The logical channel latency measurement circuitry 244 is configured to: i) measure the first latency corresponding to the transmit path at least by measuring a latency corresponding to the FIFO 224, and ii) measure the second latency corresponding to the receive path at least by measuring a latency corresponding to the FIFO 216. In some embodiments, the first latency corresponding to the transmit path is different than the second latency corresponding to the receive path, which may contribute to an asymmetry between the first logical channel latency and the second logical channel latency. Thus, measurement of the first latency corresponding to the transmit path and the second latency corresponding to the receive path facilitates compensating for the asymmetry between the first logical channel latency and the second logical channel latency, according to an embodiment.

In an embodiment, the logical channel latency measurement circuitry 244 is configured to measure the latency corresponding to the FIFO 216 by measuring a delay between i) a first time at which a data word is written to the FIFO 224 and ii) a second time at which the data word is read from the FIFO 216. In an embodiment, the delay is measured by the logical channel latency measurement circuitry 244 using a counter that operates at a frequency significantly higher than the frequency of the first clock and the frequency of the second clock. In an embodiment, the frequency at which the counter operates is at least 10 times greater than the frequency of the first clock and the frequency of the second clock. In another embodiment, the frequency at which the counter operates is at least 20 times greater than the frequency of the first clock and the frequency of the second clock. In another embodiment, the frequency at which the counter operates is at least 100 times greater than the frequency of the first clock and the frequency of the second clock. Generally, as the frequency at which the counter operates increases, the accuracy of the delay measurement increases, at least in some embodiments.

The logical channel latency measurement circuitry 244 is configured to measure the latency corresponding to the FIFO 224 in the same manner as discussed above with regard to measuring the latency corresponding to the FIFO 216, in an embodiment.

In some embodiments, the logical channel latency measurement circuitry 244 is omitted.

Latency compensation circuitry 252 is configured to add a configurable amount of delay in the first logical channel to mitigate the logical channel latency asymmetry (e.g., to make the first logical channel latency approximately equal to the second logical channel latency), in an embodiment. In an embodiment, the latency compensation circuitry 252 includes first configurable delay circuitry corresponding to the first logical channel, the first configurable delay circuitry being configured to add a configurable amount of delay in the first logical channel.

Latency compensation circuitry 256 is configured to add a configurable amount of delay in the second logical channel to mitigate the logical channel latency asymmetry (e.g., to make the first logical channel latency approximately equal to the second logical channel latency), in an embodiment. In an embodiment, the latency compensation circuitry 256 includes second configurable delay circuitry corresponding to the second logical channel, the second configurable delay circuitry being configured to add a configurable amount of delay in the second logical channel.

In various embodiments, one or both of the latency compensation circuitry 252 and the latency compensation circuitry 256 are omitted.

Latency compensation calculation circuitry 260 is configured to use the measured first physical channel latency (e.g., as measured by the physical channel latency measurement circuitry 240) to calculate one or both of i) a first amount of delay to be added to the first logic channel, and ii) a second amount of delay to be added to the second logic channel, to mitigate the logical channel latency asymmetry (e.g., to make the first logical channel latency approximately equal to the second logical channel latency), in an embodiment.

In an embodiment, the latency compensation calculation circuitry 260 is configured to also use one or both of i) the first latency corresponding to the transmit path (e.g., as measured by the logical channel latency measurement circuitry 244) and ii) the second latency corresponding to the receive path (e.g., as measured by the logical channel latency measurement circuitry 244), to calculate one or both of i) a first amount of delay to be added to the first logic channel, and ii) a second amount of delay to be added to the second logic channel, to mitigate the logical channel latency asymmetry (e.g., to make the first logical channel latency approximately equal to the second logical channel latency).

The latency compensation calculation circuitry 260 is configured to at least one of i) configure the latency compensation circuitry 252 to add the first amount of delay to the first logic channel, and ii) configure the latency compensation circuitry 256 to add the second amount of delay to the second logic channel.

In some embodiments, the latency compensation calculation circuitry 260 is omitted.

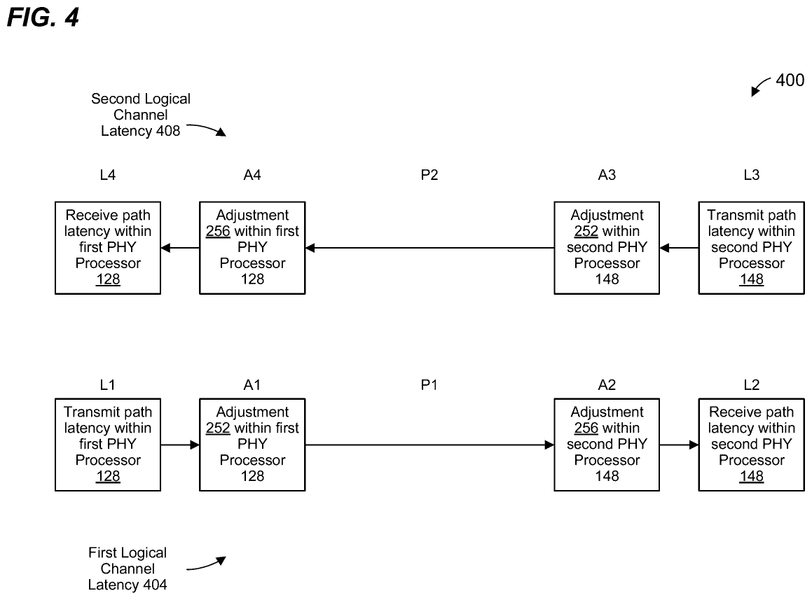

FIG. 4 is a diagram of a simplified model 400 of logical channel latencies in a communication system in which a first PHY processor (e.g., the PHY processor 128 of FIG. 1) is communicatively coupled to a second PHY processor (e.g., the PHY processor 148 of FIG. 1) via a communication link (e.g., the communication link 112 of FIG. 1), and where the first and second PHY processors each has a structure the same as or similar to the PHY processor 200 of FIG. 2, according to an embodiment. FIG. 4 is described with reference to FIGS. 1 and 2 for ease of explanation. In other embodiments, the model 400 corresponds to i) a suitable communication system different than the communication system 100 of FIG. 1 and/or ii) communication devices with PHY processors having suitable structures different than the PHY processor 200 of FIG. 2. In other embodiments, logical channel latencies in the communication system 100 are modeled differently than the simplified model 400 of FIG. 4, and/or logical channel latencies in a communication system that includes communication devices having PHY processors like the PHY processor 200 are modeled differently than the simplified model 400 of FIG. 4.

A first logical channel latency 404 corresponds to a path from the PHY processor 128 to the PHY processor 148, and a second logical channel latency 408 corresponds to a path from the PHY processor 148 to the PHY processor 128. The first logical channel latency 404 includes a plurality of components including i) a transmit path latency L1 within the PHY processor 128 (e.g., including latency due to the FIFO 224), ii) a latency adjustment A1 within the PHY processor 128 (e.g., due to latency compensation circuitry 252), iii) a physical channel latency P1, iv) a latency adjustment A2 within the PHY processor 148 (e.g., due to latency compensation circuitry 256), and v) a receive path latency L2 within the PHY processor 148 (e.g., including latency due to the FIFO 216), in an embodiment. The second logical channel latency 408 includes a plurality of components including i) a transmit path latency L3 within the PHY processor 148 (e.g., including latency due to the FIFO 224), ii) a latency adjustment A3 within the PHY processor 148 (e.g., due to latency compensation circuitry 252), iii) a physical channel latency P2, iv) a latency adjustment A4 within the PHY processor 128 (e.g., due to latency compensation circuitry 256), and v) a receive path latency L4 within the PHY processor 128 (e.g., including latency due to the FIFO 216), in an embodiment.

To mitigate logical channel asymmetry, an objective is to make the first logical channel latency 404 equal to the second logical channel latency 408, in an embodiment. The first logical channel latency 404 is modeled as:

$$First Logical Channel Latency = L 1 + A 1 + P 1 + A 2 + L 2 \qquad Equation 1$$

and the second logical channel latency 408 is modeled as:

$$Second Logical Channel Latency = L 3 + A 3 + P 2 + A 4 + L 4 \qquad Equation 2$$

Thus, in an embodiment, an objective in mitigating logical channel asymmetry is represented as:

$$L 1 + A 1 + P 1 + A 2 + L 2 = L 3 + A 3 + P 2 + A 4 + L 4 \qquad Equation 3$$

In an embodiment, the first PHY processor 128 measures L1, L4, and P1 and thus is aware of L1, L4, and P1; and the second PHY processor 148 measures L2, L3, and P2 and thus is aware of L2, L3, and P2. In an embodiment, to mitigate logical channel latency asymmetry, the first PHY processor 128 chooses A1 and A4 so that:

$$L 1 + A 1 + P 1 = A 4 + L 4 = LC 1 \qquad Equation 4$$

and the second PHY processor 148 chooses A2 and A3 so that:

$$L 3 + A 3 + P 2 = A 2 + L 2 = LC 2 \qquad Equation 5$$

Rewriting Equation 1 based on Equations 4 and 5 gives:

$$First Logical Channel Latency = LC 1 + LC 2 \qquad Equation 6$$

and rewriting Equation 2 based on Equations 4 and 5 gives:

$$Second Logical Channel Latency = LC 2 + LC 1 \qquad Equation 7$$

Thus, when the first PHY processor 128 chooses A1 and A4 according to Equation 4, and the second PHY processor 148 chooses A2 and A3 according to Equation 5, the logical channel latency asymmetry is mitigated, in an embodiment.

In an embodiment, in an implementation in which L1+P1 will always be greater than L4, the adjustable latency A1 within the PHY processor 128 is omitted (e.g., the latency compensation circuitry 252 is omitted from the PHY processor 128). Similarly, in an implementation in which L3+P2 will always be greater than L2, the adjustable latency A3 within the PHY processor 148 is omitted (e.g., the latency compensation circuitry 252 is omitted from the PHY processor 148), in an embodiment. In such an embodiment, to mitigate logical channel latency asymmetry, the first PHY processor 128 chooses A4 so that:

$$A 4 = L 1 + P 1 - L 4 \qquad Equation 8$$

and the second PHY processor 148 chooses A2 so that:

$$A 2 = L 3 + P 2 - L 2 \qquad Equation 9$$

In another embodiment in which the PHY processor 128 and the PHY processor 148 do not measure the latencies L1, L2, L3, and L4, the first logical channel latency 404 is modeled as:

$$First Logical Channel Latency = A 1 + P 1 + A 2 \qquad Equation 10$$

and the second logical channel latency 408 is modeled as:

$$Second Logical Channel Latency = A 3 + P 2 + A 4 \qquad Equation 11$$

Thus, in another embodiment, an objective in mitigating logical channel asymmetry is represented as:

$$A 1 + P 1 + A 2 = A 3 + P 2 + A 4 \qquad Equation 12$$

In an embodiment, the first PHY processor 128 measures P1 and thus is aware of P1; and the second PHY processor 148 measures P2 and thus is aware of P2. In an embodiment, to mitigate logical channel latency asymmetry, the first PHY processor 128 chooses A1 and A4 so that:

$$A 1 + P 1 = A 4 = LC 1 \qquad Equation 13$$

and the second PHY processor 148 chooses A2 and A3 so that:

$$A 3 + P 2 = A 2 = LC 2 \qquad Equation 14$$

Rewriting Equation 10 based on Equations 13 and 14 gives:

$$First Logical Channel Latency = L C 1 + L C 2 \qquad Equation 15$$

and rewriting Equation 11 based on Equations 13 and 14 gives:

$$Second Logical Channel Latency = L C 2 + L C 1 \qquad Equation 16$$

Thus, when the first PHY processor 128 chooses A1 and A4 according to Equation 13, and the second PHY processor 148 chooses A2 and A3 according to Equation 14, the logical channel latency asymmetry is mitigated, in an embodiment.

In an embodiment, the adjustable latency A1 within the PHY processor 128 is omitted (e.g., the latency compensation circuitry 252 is omitted from the PHY processor 128). Similarly, the adjustable latency A3 within the PHY processor 148 is omitted (e.g., the latency compensation circuitry 252 is omitted from the PHY processor 148), in an embodiment. In such an embodiment, to mitigate logical channel latency asymmetry, the first PHY processor 128 chooses A4 so that:

$$A 4 = P 1 \qquad Equation 17$$

and the second PHY processor 148 chooses A2 so that:

$$A 2 = P 2 \qquad Equation 18$$

In another embodiment, the second communication device 108 measures one or more latencies (e.g., one or more of P2, L2, L3) such as described above, and then transmits (e.g., via the communication link 112) the one or more measured latencies to the first communication device 104. The first communication device 104 then determines at least adjustable latencies A2 and A4 (and optionally one or both of A1 and A3) using i) one or more latencies measured by the first communication device 104 (e.g., one or more of P1, L1, L4), and ii) the one or more latencies measured by the second communication device 108 (e.g., one or more of P2, L2, L3). Next, the first communication device 104 transmits (e.g., via the communication link 112) one or more determined latencies (e.g., A2 and optionally A3) to the second communication device 108, and the second communication device 108 uses the one or more determined latencies determined by the first communication device 104 (e.g., A2 and optionally A3) when communicating with the first communication device 104.

Referring again to FIG. 2, in various embodiments, the latency compensation calculation circuitry 260 determines at least the latency A4 and optionally one or more of latencies A1, A2, and A3, using techniques such as described above. In some embodiments, the latency compensation calculation circuitry 260 controls the latency compensation circuitry 256 to add the latency A4 to the second logic channel, and optionally controls the latency compensation circuitry 252 to add the latency A1 to the first logic channel.

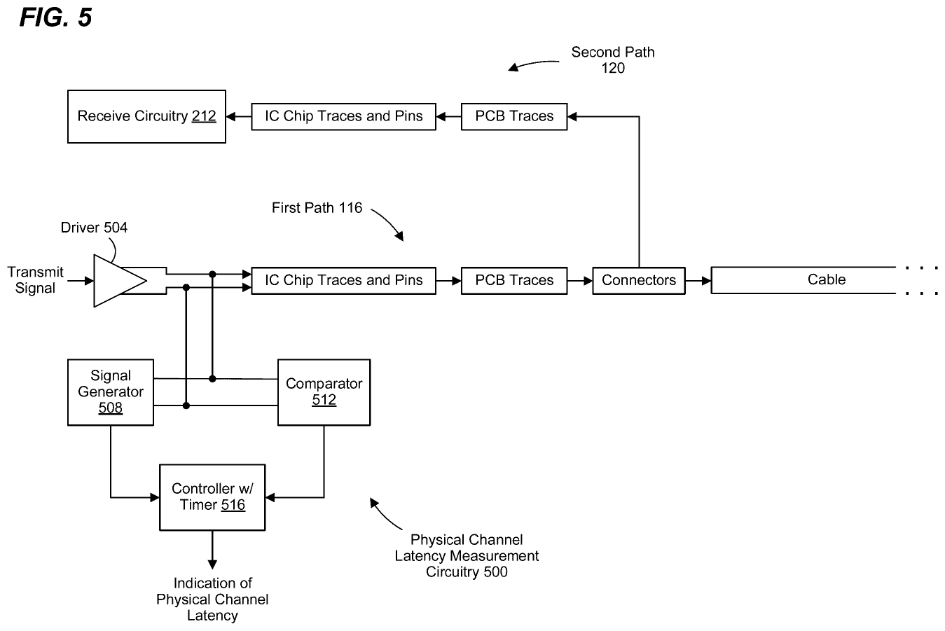

FIG. 5 is a simplified diagram of example physical channel latency measurement circuitry 500, according to an embodiment. The latency measurement circuitry 172 (FIG. 1) includes an instance of the physical channel latency measurement circuitry 500, and optionally, the latency measurement circuitry 180 (FIG. 1) includes another instance of the physical channel latency measurement circuitry 500, in an embodiment, and FIG. 5 is described with reference to FIG. 1 for ease of explanation. The physical channel latency measurement circuitry 240 (FIG. 2) includes the physical channel latency measurement circuitry 500, in an embodiment, and FIG. 5 is described also with reference to FIG. 2 for ease of explanation.

In other embodiments, the latency measurement circuitry 172 (FIG. 1) and/or the latency measurement circuitry 180 (FIG. 1) include other suitable physical channel latency measurement circuitry different than the physical channel latency measurement circuitry 500. In other embodiments, the physical channel latency measurement circuitry 240 (FIG. 2) includes other suitable physical channel latency measurement circuitry different than the physical channel latency measurement circuitry 500. Similarly, in other embodiments, the physical channel latency measurement circuitry 500 is used in another suitable communication system different than the communication system 100 of FIG. 1, in another communication device having another suitable structure different than the first communication device 104 and the second communication device 108 of FIG. 1, and/or in another suitable PHY processor different than the PHY processor 200 of FIG. 2.

The physical channel latency measurement circuitry 500 is coupled to a first transmit path from a first communication device to a second communication device (not shown). For example, the physical channel latency measurement circuitry 500 is coupled to the first path 116 from the PHY processor 128 to the PHY processor 148 (FIG. 1). The first path 116 includes a plurality of segments, including i) a first segment comprising one or more IC chip traces and IC chip pins (or other suitable IC connectors), ii) a second segment comprising one or more PCB traces, iii) a third segment comprising one or more connectors (e.g., cable connectors, backplane connectors, etc.), iv) a fourth segment comprising a cable (or other suitable communication medium), etc.

The first path 116 is also coupled to an output of driver circuitry 504 of transmit circuitry (e.g., the transmit circuitry 220 (FIG. 2)).

The physical channel latency measurement circuitry 500 includes a signal generator 508 coupled to the first path 116. In an embodiment, the signal generator 508 is coupled to the first path 116 proximate to the output of the driver circuitry 504. The signal generator 508 is configured to generate a probe signal such as an impulse signal, a pulse signal, a step signal, etc., which is then conveyed by the first path 116 to the second communication device (not shown). In an embodiment, the first path 116 is communicatively coupled to receive circuitry of the second communication device.

The physical channel latency measurement circuitry 500 also includes comparator circuitry 512 coupled to the first path 116. The comparator circuitry 512 is configured to detect an echo of the probe signal output by the signal generator 508, the echo due to the second communication device (not shown) reflecting the probe signal back along the first path 116, in an embodiment. The echo is due to receive circuitry of the second communication device reflecting the probe signal back along the first path 116, in an embodiment.

In an embodiment, the comparator circuitry 512 compares a voltage of the first path 116 to a threshold, and generates an output when the voltage of the first path 116 meets the threshold. Thus, after the probe signal has been generated by the signal generator 508, the voltage of the first path 116 meeting the threshold indicates that an echo of the probe signal was detected.

A controller 516 is configured to i) control signal generator 508 to generate the probe signal and ii) monitor when the comparator 512 detects the echo, in an embodiment. The controller 516 includes a timer and uses the timer to determine a delay between i) a first time at which the control signal generator 508 generates the probe signal, and ii) a second time at which the comparator 512 detects the echo. The controller 516 divides the delay time by two to generate an estimate of the physical channel latency of the first path 116, in an embodiment. In an embodiment, the controller 516 includes bit-shift circuitry configured to divide the delay time by two by bit-shifting the delay time towards the least significant bit to generate the estimate of the physical channel latency of the first path 116.

The controller 516 comprises a processor (not shown) that executes machine-readable instructions stored in a memory (not shown) coupled to the processor, where the machine readable instructions, when executed by the processor, cause the processor to perform operations corresponding to generating latency measurements, such as one or more of i) controlling the signal generator 508 to generate the probe signal, ii) using the timer to measure the delay time, etc., in an embodiment. In another embodiment, the controller 516 additionally or alternatively comprises a hardware state machine (not shown) that is configured to perform operations corresponding to generating latency measurements such as discussed above.

In various embodiments, one or more of i) physical channel latency measurements, ii) logical channel latency measurements, and iii) adjustments to logical channel latencies to mitigate logical channel latency asymmetry, are performed during a procedure for starting up (i.e., bringing up, initializing, etc.), a communication link. With respect to Ethernet communication links, for example, one or more of i) physical channel latency measurements, ii) logical channel latency measurements, and iii) adjustments to logical channel latencies to mitigate logical channel latency asymmetry, are performed in connection with the ANLT procedure defined by the IEEE 802.3 Standard.

In other embodiments, one or more of i) physical channel latency measurements, ii) logical channel latency measurements, and iii) adjustments to logical channel latencies to mitigate logical channel latency asymmetry, are performed during a different suitable time of operation that does not correspond to a procedure for starting up, bringing up, initializing, etc., a communication link.

The IEEE 802.3 Standard defines the ANLT to include two sequential phases: an auto-negotiation phase (AN) followed by a Link Training phase (LT). The AN permits Ethernet devices with different capabilities to communicate with one another in order to inter-operate. The AN includes two sequential sub-phases: a base page exchange, followed by an optional next page exchange. During the base page exchange, two link partners exchange information about the capabilities of each link partner, to agree on a best signaling and data encoding mode. The next page exchange may be used to facilitate additional information exchange. The IEEE 802.3 Standard does not specifically define the contents of the next page, leaving it to be vendor-proprietary. The LT phase involves exchanging training signals and adjusting component parameters.

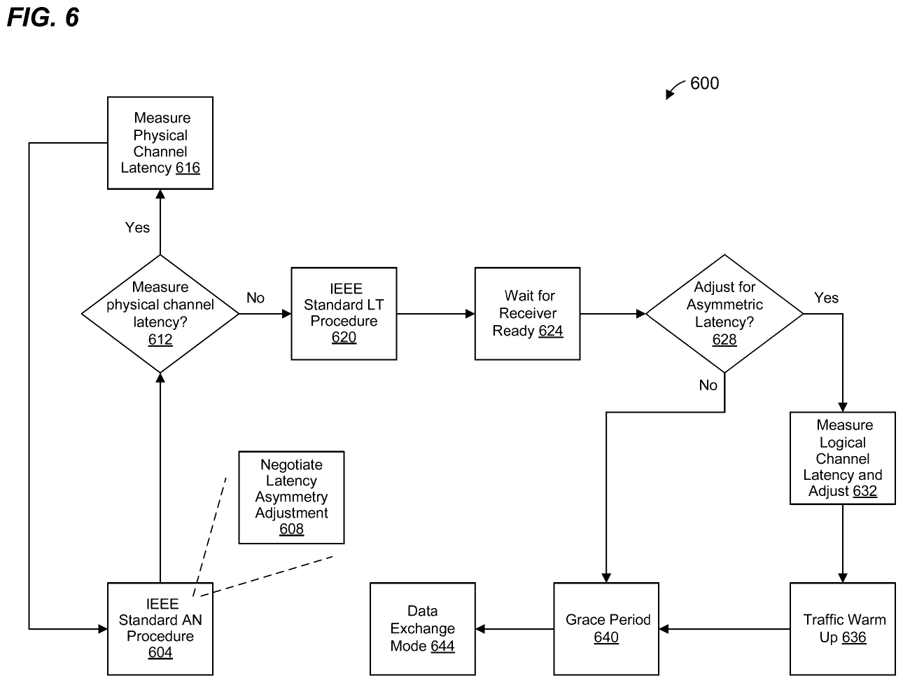

FIG. 6 is a simplified state transition diagram 600 illustrating an example modified ANLT procedure in which i) a physical channel latency measurement, ii) a logical channel latency measurement, and iii) an adjustment to a logical channel latency are performed to mitigate logical channel latency asymmetry, according to an embodiment. The modified ANLT procedure illustrated in FIG. 6 is performed by the first communication device 104 of FIG. 1, in an embodiment, and FIG. 6 is described with reference to FIG. 1 for ease of explanation. For example, the controller 192 controls transitions between, and controls operations of the first communication device 104 within, the states illustrated in FIG. 6, in an embodiment. Additionally, the second communication device 108 performs another instance of the modified ANLT procedure illustrated in FIG. 6, according to another embodiment. For example, the controller 196 controls transitions between, and controls operations of the second communication device 108 within, the states illustrated in FIG. 6, in an embodiment.

In another embodiment, the first communication device 104 and/or the second communication device 108 perform another suitable ANLT procedure different than the modified ANLT procedure of FIG. 6. In another embodiment, the modified ANLT procedure of FIG. 6 is performed by another suitable communication device different than the first communication device 104 and the second communication device 108.

The modified ANLT procedure begins in a state 604, in which an AN procedure is performed. For example, during the AN procedure a base page exchange occurs followed by a next page exchange. During the base page exchange, the first communication device 104 transmits, to the second communication device 108 via the communication link 112, capability information regarding the first communication device 104. Also during the base page exchange, the first communication device 104 receives, from the second communication device 108 via the communication link 112, capability information regarding the second communication device 108. Performing the base page exchange includes performing a procedure to select a best signaling and data encoding mode, e.g., the controller 192 and the controller 196 each select the best signaling and data encoding mode, in an embodiment.

During the next page exchange other additional information is exchanged between the first communication device 104 and the second communication device 108 via the communication link 112. For example, during an exchange 608, the first communication device 104 and the second communication device 108 exchange information to negotiate whether a procedure to mitigate asymmetric latency is to be performed, in an embodiment. As another example, during the exchange 608, the first communication device 104 and the second communication device 108 exchange information to negotiate whether a procedure to measure one or both of i) physical channel latencies and ii) logical channel latencies, is to be performed, in an embodiment. In an illustrative embodiment, the exchange 608 includes the first communication device 104 transmitting, to the second communication device 108 via the communication link 112, a request to perform the procedure to mitigate asymmetric latency (and/or to perform the procedure to measure one or both of i) physical channel latencies and ii) logical channel latencies); and the exchange 608 also includes the first communication device 104 receiving, from the second communication device 108 via the communication link 112, a response to the request. In an embodiment, in response to the response being a positive response, the first communication device 104 and the second communication device 108 determine that the procedure is to be performed; and in response to the response being a negative response (or in response to a lack of a response), the first communication device 104 and the second communication device 108 determine that the procedure is not to be performed.

In response to determining (block 612) that the procedure to measure physical channel latencies is to be performed, the first communication device 104 transitions from the state 604 to a state 616. During the state 616, the first communication device 104 measures a first physical channel latency corresponding to the first path 116 using techniques such as described above, in an embodiment.

Next, the first communication device 104 transitions from the state 616 back to the state 604, and the AN procedure is performed again during the state 604. Because the physical channel latencies were already measured, the first communication device 104 and the second communication device 108 exchange information during the exchange 608 corresponding to an agreement to skip measuring the physical channel latencies. In response to determining (block 612) that the procedure to measure physical channel latencies is to be skipped, the first communication device 104 transitions from the state 604 to a state 620.

During the state 620, an LT procedure is performed. For example, the LT procedure includes the first communication device 104 and the second communication device 108 exchanging training signals and adjusting component parameters, such as filter coefficients, echo cancellation parameters, cross-talk cancellation parameters, etc., according to various embodiments.

When the first communication device 104 completes adjustments of the component parameters and the receive circuitry 212, the first communication device 104 transitions to a state 624. During the state 624, the first communication device 104 transmits, to the second communication device 108 via the communication link 112, an indication that the first communication device 104 is ready to begin communicating via the communication link 112. Additionally, during the state 624, the first communication device 104 checks whether the second communication device 108 transmitted, via the communication link 112, an indication that the second communication device 108 is ready to begin communicating via the communication link 112.

In response to i) determining that the indication that the second communication device 108 is ready has been received, and ii) determining (628) that the procedure to mitigate asymmetric latency is to be performed (and/or that procedure to measure logical channel latencies is to be performed), the first communication device 104 transitions from the state 624 to a state 632.

During the state 632, one or more components (distinct from the physical channel latency) of logical channel latency are measured by the first communication device 104 using techniques such as described above. Additionally or alternatively, the first communication device adjusts one or both of i) a first latency of the first logical channel and ii) a second latency of the second logical channel using techniques such as described above.

In response to one or both of i) the first communication device 104 completing measurement of logical channel latencies and ii) the first communication device 104 completing adjustment of the one or both of a) the first latency of the first logical channel and b) the second latency of the second logical channel, the first communication device 104 transmits, to the second communication device 108 via the communication link, an indication that the first communication device 104 completed the one or both of i) the measurement of logical channel latencies and ii) the adjustment of the one or both of a) the first latency of the first logical channel and b) the second latency of the second logical channel. Additionally, when the first communication device 104 has received, from the second communication device 108 via the communication link 112, an indication that the second communication device 108 completed the one or both of i) the measurement of logical channel latencies and ii) the adjustment of the one or both of a) the first latency of the first logical channel and b) the second latency of the second logical channel, the first communication device 104 transitions to a state 636.

During the state 636, the first communication device 104 performs a traffic warm up procedure to warm up one or more of i) phase locked loop (PLL) circuitry of the PHY processor 128, ii) physical coding sublayer (PCS) circuitry of the PHY processor 128, and iii) forward error correction (FEC) circuitry pipelines, according to various embodiments.

In response to the first communication device 104 completing the traffic warm up procedure, the first communication device 104 transmits, to the second communication device 108 via the communication link, an indication that the first communication device 104 completed the traffic warm up procedure. Additionally, when the first communication device 104 has received, from the second communication device 108 via the communication link 112, an indication that the second communication device 108 completed the traffic warm up procedure, the first communication device 104 transitions to a state 640.

During the state 640, the first communication device 104 starts a timer. When the timer expires, the first communication device 104 transitions to a state 644 that corresponds to a regular data exchange mode of operation in which data is exchanged between the first communication device 104 and the second communication device 108.

Referring again to the state 624, in response to i) determining that the indication that the second communication device 108 is ready has been received, and ii) determining (628) that the procedure to mitigate asymmetric latency is not to be performed (and/or that procedure to measure logical channel latencies is not to be performed), the first communication device 104 transitions from the state 624 to a state 640.

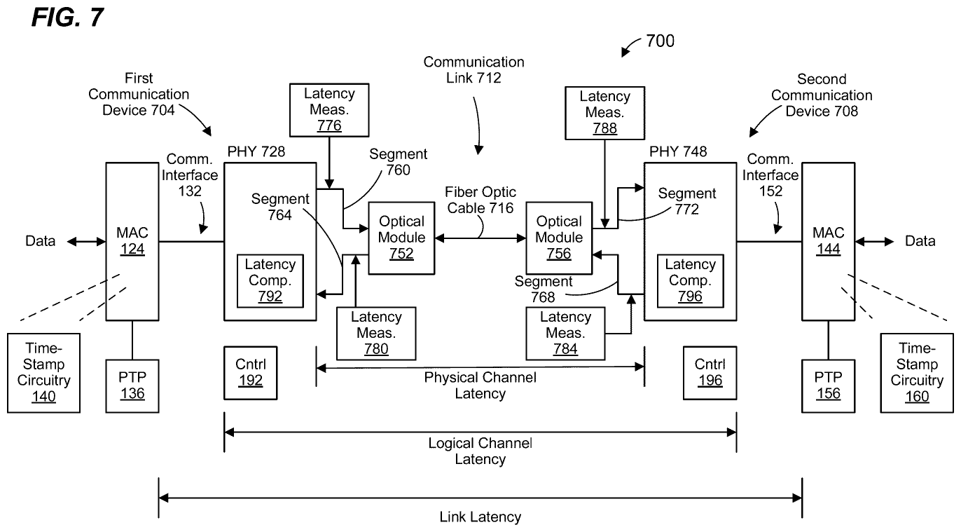

FIG. 7 is a simplified block diagram of another example communication system 700 in which an asymmetry between i) a first latency corresponding to a first communication path from a first communication device 704 to a second communication device 708, and ii) a second latency corresponding to a second communication path from the second communication device 708 to the first communication device 704 is measured and/or mitigated, according to another embodiment. The communication system 700 additionally or alternatively mitigates the asymmetry between the first latency and the second latency, in another embodiment. Measuring and/or mitigating the asymmetry between the first latency and the second latency facilitates more accurate clock synchronization as compared to conventional communication systems, according to some embodiments. Some elements of the first communication device 704 and the second communication device 708 are not illustrated in FIG. 7 to avoid obscuring the techniques described herein.

The communication system 700 is similar to the communication system 100 of FIG. 1, and like-numbered elements are not described again in detail for purposes of brevity.

The first communication device 704 and the second communication device 708 are communicatively coupled via a communication link 712. The communication link 712 comprises an optical cable, according to an embodiment. The communication link 712 also comprises components of the first communication device 104 and the second communication device 108, such as traces in an IC chip, traces in a PCB on which the IC chip is mounted, etc.

The communication link 712 comprises a first path in a first direction from the first communication device 704 to the second communication device 708, and a second path in a second direction from the second communication device 708 to the first communication device 704. The first path (which is sometimes referred to herein as a “transmit path” from the standpoint of the first communication device 704) has a first length that is different than a second length of the second path (which is sometimes referred to herein as a “receive path” from the standpoint of the first communication device 704). As a result, a first transit latency of the first path is different than a second transit latency of the second path, i.e., the transit latencies of the communication link 712 are asymmetric.

The first communication device 704 includes a PHY processor 728 similar to the PHY processor 128 (FIG. 1), and the second communication device 708 includes a PHY processor 748 similar to the PHY processor 148 (FIG. 1). The first communication device 704 also comprises an optical module 752 communicatively coupled to the PHY processor 728 and to the fiber optic cable 716. The second communication device 708 also comprises an optical module 756 communicatively coupled to the PHY processor 748 and to the fiber optic cable 716.

The optical module 752 is configured to receive an electrical transmit signal from transmit circuitry of the PHY processor 728 and convert the electrical transmit signal to an optical transmit signal for transmission via the fiber optic cable 716. The optical module 752 is also configured to receive an optical receive signal from the fiber optic cable 716 and convert the optical receive signal to an electrical receive signal to be provided to the PHY processor 728. The optical module 752 includes one or more of i) one or more lasers, ii) an optical modulator, iii) an optical demodulator, iv) one or more photo diodes, etc., according to various embodiments.

The optical module 756 has a structure the same as or similar to the optical module 752, in an embodiment.

Transmit circuitry of the PHY module 728 is communicatively coupled to the optical module 752 via a segment 760 of the first path, and receive circuitry of the PHY module 728 is communicatively coupled to the optical module 752 via a segment 764 of the second path. Similarly, transmit circuitry of the PHY module 748 is communicatively coupled to the optical module 756 via a segment 768 of the second path, and receive circuitry of the PHY module 748 is communicatively coupled to the optical module 756 via a segment 772 of the first path. Thus, the first path includes i) the segment 760, the fiber optic cable 716, and the segment 772. The second path includes i) the segment 768, the fiber optic cable 716, and the segment 764.

The latencies of the fiber optic cable 716 can be assumed to be symmetric. However, a length of the segment 760 is typically different than a length of the segment 764, and a length of the segment 768 is typically different than a length of the segment 772. Each of the segments 760, 764, 768, 772 includes one or more of i) one or more respective IC traces, ii) one or more respective PCB traces, etc.

The first communication device 704 includes latency measurement circuitry 776 coupled to the segment 760 proximate to transmit circuitry of the PHY processor 728. The latency measurement circuitry 776 is configured to measure a first physical channel latency (P1) of the segment 760. In an embodiment, the latency measurement circuitry 776 is configured to i) transmit a probe signal (e.g., an impulse signal, a pulse, etc.) in the segment 760, ii) detect a reflection of the probe signal in the segment 760, and iii) use the detected reflection to determine P1. In other embodiments, the latency measurement circuitry 776 measures P1 in another suitable manner.

The first communication device 704 also includes latency measurement circuitry 780 coupled to the segment 764 proximate to the optical module 752. The latency measurement circuitry 780 is configured to measure a second physical channel latency (P2) of the segment 764. In an embodiment, the latency measurement circuitry 780 is configured to i) transmit a probe signal (e.g., an impulse signal, a pulse, etc.) in the segment 764, ii) detect a reflection of the probe signal in the segment 764, and iii) use the detected reflection to determine P2. In other embodiments, the latency measurement circuitry 780 measures P2 in another suitable manner.

The second communication device 708 includes latency measurement circuitry 784 coupled to the segment 768 proximate to transmit circuitry of the PHY processor 748. The latency measurement circuitry 784 is configured to measure a third physical channel latency (P3) of the segment 768. In an embodiment, the latency measurement circuitry 784 is configured to i) transmit a probe signal (e.g., an impulse signal, a pulse, etc.) in the segment 768, ii) detect a reflection of the probe signal in the segment 768, and iii) use the detected reflection to determine P3. In other embodiments, the latency measurement circuitry 784 measures P3 in another suitable manner.

The second communication device 708 also includes latency measurement circuitry 788 coupled to the segment 772 proximate to the optical module 756. The latency measurement circuitry 788 is configured to measure a fourth physical channel latency (P4) of the segment 772. In an embodiment, the latency measurement circuitry 788 is configured to i) transmit a probe signal (e.g., an impulse signal, a pulse, etc.) in the segment 772, ii) detect a reflection of the probe signal in the segment 772, and iii) use the detected reflection to determine P4. In other embodiments, the latency measurement circuitry 788 measures P4 in another suitable manner.

In an embodiment, each of the latency measurement circuitry 776, 780, 784, 788 has a structure the same as or similar to the latency measurement circuitry 500 of FIG. 5. In other embodiments, one or more of the latency measurement circuitry 776, 780, 784, 788 has another suitable structure different than the latency measurement circuitry 500.

In some embodiments, the PHY processor 728 includes additional latency measurement circuitry that is configured to measure one or both of i) a first additional component of the first logical channel latency and ii) a first additional component of the second logical channel latency. In some embodiments, the PHY processor 748 includes additional latency measurement circuitry that is configured to measure one or both of i) a second additional component of the first logical channel latency and ii) a second additional component of the second logical channel latency.

Latency compensation circuitry 792 of the first communication device 704 is configured to use P1 and P2 (and optionally one or both of i) the first additional component of the first logical channel latency and ii) the first additional component of the second logical channel latency) to adjust one or both of the first logical channel latency and the second logical channel latency to mitigate the logical channel latency asymmetry (e.g., to make the first logical channel latency approximately equal to the second logical channel latency).

The latency compensation circuitry 792 has a structure the same as or similar to the latency compensation circuitry 176 (FIG. 1) and/or the circuitry 252, 256, 260 (FIG. 2), in various embodiments. In other embodiments, the latency compensation circuitry 792 has another suitable structure.

Latency compensation circuitry 796 of the second communication device 708 is configured to use P3 and P4 (and optionally one or both of i) the second additional component of the first logical channel latency and ii) the second additional component of the second logical channel latency) to adjust one or both of the first logical channel latency and the second logical channel latency to mitigate the logical channel latency asymmetry (e.g., to make the first logical channel latency approximately equal to the second logical channel latency).

The latency compensation circuitry 796 has a structure the same as or similar to the latency compensation circuitry 184 (FIG. 1) and/or the circuitry 252, 256, 260 (FIG. 2), in various embodiments. In other embodiments, the latency compensation circuitry 796 has another suitable structure.

To mitigate logical channel asymmetry, an objective is to make the first logical channel latency equal to the second logical channel latency, in an embodiment. Referring to FIGS. 4 and 7, the first logical channel latency is modeled as:

$$Equation 19$$

$$First Logical Channel Latency = L 1 + A 1 + P 1 + P 4 + A 2 + L 2$$

and the second logical channel latency 408 is modeled as:

$$Equation 20$$

$$Second Logical Channel Latency = L 3 + A 3 + P 2 + P 3 + A 4 + L 4$$

where the latencies of the fiber optical cable 716 are ignored because they are symmetric.

Thus, in an embodiment, an objective in mitigating logical channel asymmetry is represented as:

$$L 1 + A 1 + P 1 + P 4 + A 2 + L 2 = L 3 + A 3 + P 2 + P 3 + A 4 + L 4 \qquad Equation 21$$

In an embodiment, the first PHY processor 728 measures L1, L4, P1, P2, and thus is aware of L1, L4, P1, and P2; and the second PHY processor 148 measures L2, L3, P3, and P4 and thus is aware of L2, L3, P3, and P4. In an embodiment, to mitigate logical channel latency asymmetry, the first PHY processor 728 chooses A1 and A4 so that:

$$L 1 + A 1 + P 1 = A 4 + L 4 + P 2 = LC 1 \qquad Equation 22$$

and the second PHY processor 248 chooses A2 and A3 so that:

$$L 3 + A 3 + P 4 = A 2 + L 2 + P 3 = LC 2 \qquad Equation 23$$

Rewriting Equation 19 based on Equations 22 and 23 gives:

$$First Logical Channel Latency = L C 1 + L C 2 \qquad Equation 24$$

and rewriting Equation 20 based on Equations 22 and 23 gives:

$$Second Logical Channel Latency = L C 2 + L C 1 \qquad Equation 25$$

Thus, when the first PHY processor 728 chooses A1 and A4 according to Equation 22, and the second PHY processor 748 chooses A2 and A3 according to Equation 23, the logical channel latency asymmetry is mitigated, in an embodiment.

In another embodiment, the communication system 700 is modified to work with a wireless communication medium. For example, the optical module 752, the optical module 756, and the fiber optic cable 716 are omitted. In an embodiment, the segment 760 of the first path is coupled to a first antenna, and the segment 780 of the second path is coupled to the first antenna. In an embodiment, the segment 772 of the first path is coupled to a second antenna, and the segment 768 of the second path is coupled to the second antenna. The PHY processor 728 includes i) first transmit circuitry configured to generate a first transmit signal for transmission via the first antenna, and ii) first receive circuitry configured to process a first receive signal received via the first antenna, in an embodiment. The PHY processor 748 includes i) second transmit circuitry configured to generate a second transmit signal for transmission via the second antenna, and ii) second receive circuitry configured to process a second receive signal received via the second antenna, in an embodiment.

In some such embodiments, the latency measurement circuitry 776 is configured to measure the latency P1 of the segment 760 from the first transmit circuitry to the first antenna; the latency measurement circuitry 780 is configured to measure the latency P2 of the segment 764 from the first antenna to the first receive circuitry; the latency measurement circuitry 788 is configured to measure the latency P3 of the segment 772 from the second antenna to the second receive circuitry; and the latency measurement circuitry 784 is configured to measure the latency P4 of the segment 768 from the second transmit circuitry to the second antenna.

Referring now to FIGS. 1 and 7, in some embodiments, latency asymmetry of a communication device (e.g., one or more of the communication device 104, the communication device 108, the communication device 704, the communication device 708, etc.) is measured and/or calculated during a design phase and/or a manufacturing phase of a communication device, and the communication device is configured to compensate for the latency asymmetry of the communication device (and optionally latency asymmetry of another communication device) that was measured and/or calculated during the design phase and/or the manufacturing phase. In some such embodiments, one or more of the latency measurement circuitry 172, the latency measurement circuitry 180, the latency measurement circuitry 776, the latency measurement circuitry 780, the latency measurement circuitry 784, and the latency measurement circuitry 788 are omitted. For example, latencies P1 and P2 (and optionally latencies P3 and P4) described with reference to FIG. 7 are measured and/or calculated during the design phase and/or the manufacturing phase, according to an embodiment.

In some such embodiments, latency compensation circuitry (e.g., the latency compensation circuitry 176, the latency compensation circuitry 184, the latency compensation circuitry 792, the latency compensation circuitry 796, etc.) compensates for the latency asymmetry that was measured and/or calculated during the design phase and/or the manufacturing phase using techniques such as described above. For example, the latency compensation circuitry compensates for the latency asymmetry that was measured and/or calculated during the design phase and/or the manufacturing phase using techniques such as described above with reference to FIG. 7 and Equations 21-25.

In some embodiments, the latency compensation circuitry is configured during the manufacturing phase to compensate for the latency asymmetry that was measured and/or calculated during the design phase and/or the manufacturing phase using techniques such as described above. For example, the latency compensation circuitry is configured during the manufacturing phase to compensate for the latency asymmetry that was measured and/or calculated during the design phase and/or the manufacturing phase using techniques such as described above, according to an embodiment. For example, a configurable delay in the transmit path and/or a configurable delay in the receive path are configured during the manufacturing phase to compensate for the latency asymmetry that was measured and/or calculated during the design phase and/or the manufacturing phase, according to an embodiment.

In some embodiments, the latency compensation circuitry is configured during a startup procedure (such as described above) to compensate for the latency asymmetry that was measured and/or calculated during the design phase and/or the manufacturing phase using techniques such as described above. In some embodiments, communication devices exchange latency asymmetry information (which was measured and/or calculated during the design phase and/or the manufacturing phase) during the startup procedure (e.g., using next page messages) and use the exchanged asymmetry information to compensate for the latency asymmetry using techniques such as described above.

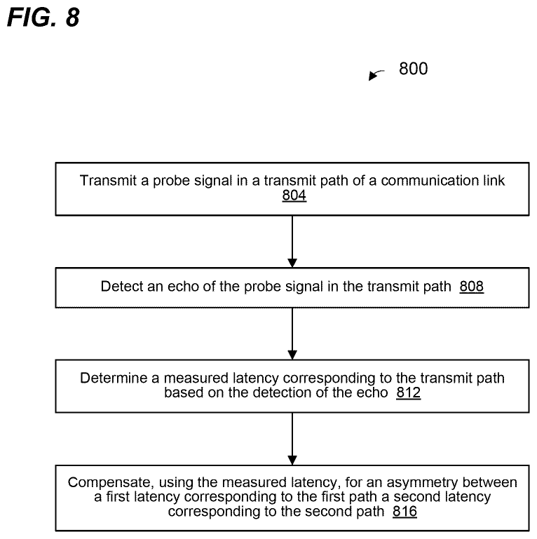

FIG. 8 is a flow diagram of an example method 800 for improving time synchronization in a communication network, according to an embodiment. The method 800 is implemented in the communication system 100 of FIG. 1, in an embodiment. For example, the method 800 is implemented at least by the first communication device 104, in an embodiment. The method 800 is implemented in the communication system 700 of FIG. 7, in another embodiment. For example, the method 800 is implemented at least by the first communication device 704, in another embodiment. For ease of explanation, the method 800 is described with reference to FIGS. 1 and 7. In other embodiments, the method 800 is implemented in another suitable communication system different than the communication system 100 and the communication system 700 of FIGS. 1 and 7, respectively. In other embodiments, the communication system 100 and/or the communication system 700 of FIGS. 1 and 7, respectively, implement other suitable methods for improving time synchronization different than the method 800.

At block 804, a first communication device transmits a probe signal in a transmit path of a communication link coupled to a second communication device, the communication link also including a receive path. A first latency of the transmit path is different than a second latency of the receive path. For example, the latency measurement circuitry 172 transmits a probe signal in the first path 116. As another example, the latency measurement circuitry 776 transmits a probe signal in the segment 760.

At block 808, the first communication device detects an echo of the probe signal in the transmit path of the communication link. For example, the latency measurement circuitry 172 detects an echo of the probe signal in the first path 116. As another example, the latency measurement circuitry 776 detects an echo of the probe signal in the segment 760.

At block 812, the first communication device determines a measured latency corresponding to the transmit path based on the detection of the echo. For example, the latency measurement circuitry 172 determines a measured latency corresponding to the first path 116 based on the detection of the echo. As another example, the latency measurement circuitry 776 determines a measured latency corresponding to the transmit path based on the detection of the echo.

At block 816, the first communication device compensates, using the measured latency, for an asymmetry between the first latency of the transmit path and the second latency of the receive path. For example, the latency compensation circuitry 176 compensates, using the measured latency, for an asymmetry between the first latency of the transmit path 116 and the receive path 120. As another example, the latency compensation circuitry 792 compensates, using the measured latency, for an asymmetry between the first latency of the transmit path and the receive path.

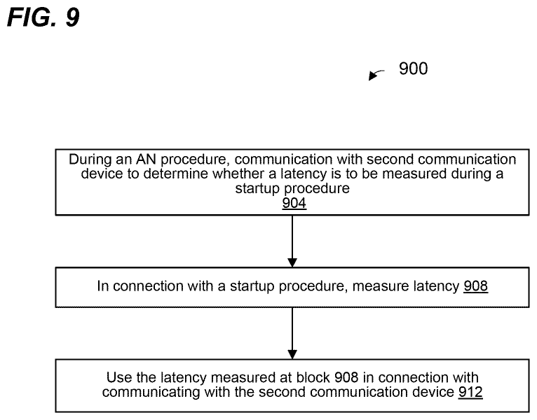

FIG. 9 is a flow diagram of an example method 900 for measuring latency of a communication link in a communication network, according to another embodiment. The method 900 is implemented in the communication system 100 of FIG. 1, in an embodiment. For example, the method 900 is implemented at least by the first communication device 104, in an embodiment. The method 900 is implemented in the communication system 700 of FIG. 7, in another embodiment. For example, the method 900 is implemented at least by the first communication device 704, in another embodiment. For ease of explanation, the method 900 is described with reference to FIGS. 1, 6, and 7. In other embodiments, the method 900 is implemented in another suitable communication system different than the communication system 100 and the communication system 700 of FIGS. 1 and 7, respectively. In another embodiment, the method 900 is implemented in connection with another set of state transitions different than the set of state transitions of FIG. 6. In other embodiments, the communication system 100 and/or the communication system 700 of FIGS. 1 and 7, respectively, implement other suitable methods for measuring latency of a communication link different than the method 900.

At block 904, a first communication device communicates, during an AN procedure, with a second communication device via the communication link to determine whether a latency corresponding to the communication link is to be measured during a procedure for starting up the communication link. In an embodiment, the AN procedure is defined by a communication protocol according to which the first communication device is configured to operate. In an embodiment, the AN procedure is defined by the IEEE 802.3 Standard. The AN procedure is designed to permit communication devices to communicate device capability information with one another in facilitate selecting a common signaling and data encoding mode that both communication devices are capable of using, in an embodiment. The AN includes two sequential sub-phases: a base page exchange, followed by an optional next page exchange; and communicating at block 904 comprises exchanging next page messages with the second communication device during the next page exchange, in an embodiment.

At block 908, in connection with the procedure for starting up the communication link, the first communication device measures the latency corresponding to the communication link. In an embodiment, the first communication device measures a physical channel latency corresponding to the communication link. For example, the first communication device 104 measures a physical channel latency corresponding to the first path 116 corresponding to the communication link 112. As another embodiment, the first communication device 704 measures a physical channel latency corresponding to the segment 760 of the first path corresponding to the communication link 712. As another embodiment, the first communication device 704 measures a physical channel latency corresponding to the segment 764 of the second path corresponding to the communication link 712.

Measuring the latency corresponding to the communication link at block 908 comprises: transmitting a probe signal via a first path corresponding to the communication link; detecting an echo of the probe signal in the first path; and measuring the latency based on the detecting of the echo in the first path, in an embodiment. In an embodiment, the first path corresponds to at least a segment of a transmit path from a standpoint of the first communication device; and the communication link also comprises a receive path from the standpoint of the first communication device. In another embodiment, the first path corresponds to a segment of a receive path from the standpoint of the first communication device; and the communication link also comprises a transmit path from the standpoint of the first communication device.

At block 912, the first communication device uses the latency measured at block 908 in connection with communicating with the second communication device via the communication link. In an embodiment, using the latency at block 912 comprises the first communication device using the latency measured at block 908 to mitigate an asymmetry between a first latency corresponding to a first path of the communication link (e.g., a transmit path from the standpoint of the first communication device) and a second path of the communication link (e.g., a receive path from the standpoint of the first communication device). In an embodiment, using the latency at block 912 comprises the first communication device using the latency measured at block 908 to mitigate an asymmetry between a first latency corresponding to a first path of the communication link (e.g., a transmit path from the standpoint of the first communication device) and a second latency corresponding to a second path of the communication link (e.g., a receive path from the standpoint of the first communication device). For example, the first communication device 104 uses (e.g., the latency compensation circuitry 176 uses) the latency measured at block 908 to mitigate an asymmetry between a first latency corresponding to the transmit path 116 and a second latency corresponding to the second path 120. As another example, the first communication device 704 uses (e.g., the latency compensation circuitry 792 uses) the latency measured at block 908 to mitigate an asymmetry between a first latency corresponding to the first path and a second latency corresponding to the second path.

In another embodiment, using the latency at block 912 comprises the first communication device using the latency measured at block 908 in connection with synchronizing a first clock of the first communication device with a second clock of the second communication device. For example, the PTP controller 136 uses the latency measured at block 908 in connection with synchronizing a first clock of the first communication device with a second clock of the second communication device.

In another embodiment, using the latency at block 912 comprises the first communication device using the latency measured at block 908 to account for delays in exchanging messages between the first communication device and the second communication device via the communication link. For example, the PTP controller 136 uses the latency measured at block 908 to account for delays in exchanging PTP messages between the first communication device and the second communication device via the communication link.

In another embodiment, using the latency at block 912 comprises the first communication device using the latency measured at block 908 to determine a distance between the first communication device and the second communication device; and using the determined distance in connection with communicating with the second communication device.

In some embodiments, the method 900 is performed in combination with the method 800 (FIG. 8). For example, measuring latency at block 908 (FIG. 9) comprises performing the operations of blocks 804, 808, and 812 (FIG. 8), and using the latency at block 912 (FIG. 9) comprises compensation for latency asymmetry at block 816 (FIG. 8), in an embodiment. In other embodiments, the method 900 of FIG. 9 is not performed in combination with the method 800 of FIG. 8. As an example, the operations of blocks 804, 808, and 812 (FIG. 8) are not performed in connection with a startup procedure, in some embodiments. As another example, using the measured latency at block 912 does not comprise using the latency to compensate for latency asymmetry (block 816).

Embodiment 1: A network device configured to operate in a communication network, the network device comprising: transmit circuitry configured to couple with a transmit path of a communication link; receive circuitry configured to couple with a receive path of the communication link, the receive circuitry comprising decoding circuitry configured to decode data units received by the receive circuitry; latency measurement circuitry coupled to the transmit path, the latency measurement circuitry configured to generate a measurement of a first latency of the transmit path; and latency compensation circuitry communicatively coupled to one or both of the transmit circuitry and the receive circuitry, the latency compensation circuitry configured to compensate for an asymmetry between the first latency of the transmit path and a second latency of the receive path using at least the measurement of the first latency.

Embodiment 2: The network device of embodiment 1, wherein the latency compensation circuitry is configured to: generate the measurement of the first latency based on i) a transmission of a probe signal in the transmit path by the network device and ii) reception of an echo of the probe signal in the transmit path.

Embodiment 3: The network device of embodiment 2, wherein the latency compensation circuitry comprises: signal generator circuitry coupled to the transmit path, the signal generator circuitry configured to generate the probe signal in the transmit path; echo detection circuitry coupled to the transmit path, the echo detection circuitry configured to detect the echo of the probe signal in the transmit path; and a controller coupled to the signal generator circuitry and to the echo detection circuitry, the controller configured to generate the measurement of the first latency based on i) a generation of the probe signal by the signal generator circuitry and ii) a detection of the echo by the echo detection circuitry.

Embodiment 4: The network device of embodiment 3, wherein controller comprises a counter, and wherein the controller is configured to: measure, with the counter, a delay between i) a first time at which the signal generator circuitry generates the probe signal in the transmit path, and ii) a second time at which the echo detection circuitry detects the echo in the transmit path; and determine the measurement of the first latency using the delay.

Embodiment 5: The network device of any of embodiments 1-4, wherein the latency compensation circuitry comprises: configurable delay circuitry coupled to a receive logical channel that includes the receive path, the configurable delay circuitry configured to add a configurable amount of delay in the receive logical channel; and latency compensation calculation circuitry configured to determine, using the measurement of the first latency, the configurable amount of delay to be added by the configurable delay circuitry.

Embodiment 6: The network device of any of embodiments 1-5, wherein: the latency measurement circuitry is physical channel latency measurement circuitry; the network device further comprises logical channel latency measurement circuitry configured to measure i) a second latency corresponding to a transmit logical channel that includes the transmit path, and ii) a third latency corresponding to a receive logical channel that includes the receive path; and the latency compensation circuitry is further configured to compensate for an asymmetry between i) the second latency corresponding to the transmit logical channel and ii) the third latency corresponding to the receive logical channel.

Embodiment 7: The network device of embodiment 6, wherein the latency compensation circuitry comprises: configurable delay circuitry coupled to the receive logical channel, the configurable delay circuitry configured to add a configurable amount of delay in the receive logical channel; and latency compensation calculation circuitry configured to determine the configurable amount of delay to be added by the configurable delay circuitry using i) the measurement of the first latency, ii) the second latency, and iii) the third latency.

Embodiment 8: The network device of any of embodiments 1-7, wherein the latency compensation circuitry is configured to compensate for the asymmetry between the first latency of the transmit path and the second latency of the receive path further using a measurement of the second latency of the receive path received from the second communication device via the communication link.

Embodiment 9: The network device of any of embodiments 1-8, wherein the latency compensation circuitry comprises: a controller coupled to the transmit circuitry, the controller configured to cause the transmit circuitry to transmit the measured first latency of the transmit path to the second communication device to facilitate the second communication device using the measurement of the first latency to compensate for the asymmetry between the first latency of the transmit path and the second latency of the receive path.

Embodiment 10: A method for improving time synchronization in a communication network, the method comprising: generating, at a first communication device, a measurement of a first latency of a transmit path of a communication link between the first communication device and a second communication device, the communication link also including a receive path; and compensating, by the first communication device, for an asymmetry between the first latency of the transmit path and a second latency of the receive path using the measurement of the first latency.

Embodiment 11: The method for improving time synchronization of embodiment 10, wherein generating the measurement of the first latency of the transmit path comprises: transmitting, by the first communication device, a probe signal via the transmit path to the second communication device; receiving, at the first communication device, an echo of the probe signal via the transmit path; and generating, at the first communication device, the measurement of the first latency based on the transmitting of the probe signal and the receiving of the echo.

Embodiment 12: The method for improving time synchronization of embodiment 11, wherein generating the measurement of the first latency of the transmit path further comprises: measuring, with a counter, a delay between i) a first time at which the first communication device transmits the probe signal, and ii) a second time at which the first communication device detects the echo; and determining, at the first communication device, the first latency using the delay.

Embodiment 13: The method for improving time synchronization of any of embodiments 10-12, wherein compensating for the asymmetry between the first latency of the transmit path and the second latency of the receive path comprises: determining, at the first communication device, a compensation latency to add to a receive logical channel that includes the receive path using the measurement of the first latency; and adding, at the first communication device, the compensation latency to the receive logical channel to compensate for the asymmetry between the first latency of the transmit path and the second latency of the receive path.

Embodiment 14: The method for improving time synchronization of any of embodiments 10-13, further comprising: measuring, at the first communication device, a second latency corresponding to a transmit logical channel that includes the transmit path; measuring, at the first communication device, a third latency corresponding to a receive logical channel that includes the receive path; and compensating, by the first communication device, for an asymmetry between i) the second latency corresponding to the transmit logical channel and ii) the third latency corresponding to the receive logical channel.

Embodiment 15: The method for improving time synchronization of embodiment 14, wherein i) compensating for the asymmetry between the first latency of the transmit path and the second latency of the receive path, and ii) compensating for the asymmetry between the second latency corresponding to the transmit logical channel and the third latency corresponding to the receive logical channel, comprises: determining, at the first communication device, a compensation latency to add to a receive logical channel that includes the receive path using i) the first latency, ii) the second latency, and iii) the third latency; and adding, at the first communication device, the compensation latency to the receive logical channel to compensate for i) the asymmetry between the first latency of the transmit path and the second latency of the receive path, and ii) the asymmetry between the second latency corresponding to the transmit logical channel and the third latency corresponding to the receive logical channel.

Embodiment 16: The method for improving time synchronization of any of embodiments 10-15, further comprising: receiving, at the first communication device, a measurement of the second latency of the receive path of the communication link from the second communication device; wherein compensating for the asymmetry between the first latency of the transmit path and the second latency of the receive path comprises further using the measurement of the second latency received from the second communication device.

Embodiment 17: The method for improving time synchronization of any of embodiments 10-16, wherein compensating for the asymmetry between the first latency of the transmit path and the second latency of the receive path comprises: transmitting, by the first communication device, the measured first latency of the transmit path to the second communication device to facilitate the second communication device using the measurement of the first latency to compensate for the asymmetry between the first latency of the transmit path and the second latency of the receive path.

Embodiment 18: A communication system, comprising: a first network device coupled to a communication link, the first network device comprising first transmit circuitry coupled to a first path of the communication link and first receive circuitry coupled to a second path of the communication link; and a second network device coupled to the communication link, the second network device comprising second transmit circuitry coupled to the second path of the communication link and second receive circuitry coupled to the first path of the communication link; the first network device further comprising: first latency measurement circuitry coupled to the first path, the first latency measurement circuitry configured to generate a measurement a first latency of the first path, and first latency compensation circuitry communicatively coupled to one or both of the first transmit circuitry and the first receive circuitry, the first latency compensation circuitry configured to compensate for an asymmetry between the first latency of the first path and a second latency of the second path using the measurement of the first latency; and the second network device further comprising: second latency measurement circuitry coupled to the second path, the second latency measurement circuitry configured to generate a measurement of the second latency of the second path, and second latency compensation circuitry communicatively coupled to one or both of the second transmit circuitry and the second receive circuitry, the second latency compensation circuitry configured to compensate for asymmetry between the first latency of the first path and the second latency of the second path using the measurement of the second latency.

Embodiment 19: The communication system of embodiment 18, wherein: the first latency compensation circuitry comprises: first signal generator circuitry coupled to the first path, the first signal generator circuitry configured to generate a first probe signal in the first path, first echo detection circuitry coupled to the first path, the first echo detection circuitry configured to detect a first echo of the first probe signal in the first path, and a first controller coupled to the first signal generator circuitry and the first echo detection circuitry, the first controller configured to generate the measurement of the first latency based on i) a generation of the first probe signal by the first signal generator circuitry and ii) a detection of the first echo by the first echo detection circuitry; and the second latency compensation circuitry comprises: second signal generator circuitry coupled to the second path, the second signal generator circuitry configured to generate a second probe signal in the second path, second echo detection circuitry coupled to the second path, the second echo detection circuitry configured to detect a second echo of the second probe signal in the second path, and a second controller coupled to the second signal generator circuitry and the second echo detection circuitry, the second controller configured to generate the measurement of the second latency based on i) a generation of the second probe signal by the second signal generator circuitry and ii) a detection of the second echo by the second echo detection circuitry.

Embodiment 20: The communication system of embodiment 19, wherein: the first controller comprises a first counter, and wherein the first controller is configured to: measure, with the first counter, a first delay between i) a first time at which the first signal generator circuitry generates the first probe signal in the first path, and ii) a second time at which the first echo detection circuitry detects the first echo in the first path, and determine the measurement of the first latency using the first delay; and the second controller comprises a second counter, and wherein the second controller is configured to: measure, with the second counter, a second delay between i) a third time at which the second signal generator circuitry generates the second probe signal in the second path, and ii) a fourth time at which the second echo detection circuitry detects the second echo in the second path, and determine the measurement of the second latency using the second delay.

Embodiment 21: The communication system of any of embodiments 18-20, wherein: the first latency compensation circuitry comprises: first configurable delay circuitry coupled to a first logical channel that includes the second path, the first configurable delay circuitry configured to add a first configurable amount of delay in the first logical channel, and first latency compensation calculation circuitry configured to determine, using the measurement of the first latency, the first configurable amount of delay to be added by the first configurable delay circuitry; and the second latency compensation circuitry comprises: second configurable delay circuitry coupled to a second logical channel that includes the first path, the second configurable delay circuitry configured to add a second configurable amount of delay in the second logical channel, and second latency compensation calculation circuitry configured to determine, using the measurement of the second latency, the second configurable amount of delay to be added by the second configurable delay circuitry.

Some of the various blocks, operations, and techniques described above may be implemented utilizing hardware, a processor executing firmware instructions, a processor executing software instructions, or any suitable combination thereof. When implemented utilizing a processor executing software or firmware instructions, the software or firmware instructions may be stored in any suitable computer readable memory. The software or firmware instructions may include machine readable instructions that, when executed by one or more processors, cause the one or more processors to perform various acts.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A network device configured to operate in a communication network, the network device comprising:
transmit circuitry configured to couple with a transmit path of a communication link;
receive circuitry configured to couple with a receive path of the communication link, the receive circuitry comprising decoding circuitry configured to decode data units received by the receive circuitry;
latency measurement circuitry coupled to the transmit path, the latency measurement circuitry configured to generate a measurement of a first latency of the transmit path; and
latency compensation circuitry communicatively coupled to one or both of the transmit circuitry and the receive circuitry, the latency compensation circuitry configured to compensate for an asymmetry between the first latency of the transmit path and a second latency of the receive path using at least the measurement of the first latency.

2. The network device of claim 1, wherein the latency compensation circuitry is configured to:
generate the measurement of the first latency based on i) a transmission of a probe signal in the transmit path by the network device and ii) reception of an echo of the probe signal in the transmit path.

3. The network device of claim 2, wherein the latency compensation circuitry comprises:
signal generator circuitry coupled to the transmit path, the signal generator circuitry configured to generate the probe signal in the transmit path;
echo detection circuitry coupled to the transmit path, the echo detection circuitry configured to detect the echo of the probe signal in the transmit path; and
a controller coupled to the signal generator circuitry and to the echo detection circuitry, the controller configured to generate the measurement of the first latency based on i) a generation of the probe signal by the signal generator circuitry and ii) a detection of the echo by the echo detection circuitry.

4. The network device of claim 3, wherein controller comprises a counter, and wherein the controller is configured to:
measure, with the counter, a delay between i) a first time at which the signal generator circuitry generates the probe signal in the transmit path, and ii) a second time at which the echo detection circuitry detects the echo in the transmit path; and
determine the measurement of the first latency using the delay.

5. The network device of claim 1, wherein the latency compensation circuitry comprises:
configurable delay circuitry coupled to a receive logical channel that includes the receive path, the configurable delay circuitry configured to add a configurable amount of delay in the receive logical channel; and
latency compensation calculation circuitry configured to determine, using the measurement of the first latency, the configurable amount of delay to be added by the configurable delay circuitry.

6. The network device of claim 1, wherein:
the latency measurement circuitry is physical channel latency measurement circuitry;
the network device further comprises logical channel latency measurement circuitry configured to measure i) a second latency corresponding to a transmit logical channel that includes the transmit path, and ii) a third latency corresponding to a receive logical channel that includes the receive path; and
the latency compensation circuitry is further configured to compensate for an asymmetry between i) the second latency corresponding to the transmit logical channel and ii) the third latency corresponding to the receive logical channel.

7. The network device of claim 6, wherein the latency compensation circuitry comprises:
configurable delay circuitry coupled to the receive logical channel, the configurable delay circuitry configured to add a configurable amount of delay in the receive logical channel; and
latency compensation calculation circuitry configured to determine the configurable amount of delay to be added by the configurable delay circuitry using i) the measurement of the first latency, ii) the second latency, and iii) the third latency.

8. The network device of claim 1, wherein the latency compensation circuitry is configured to compensate for the asymmetry between the first latency of the transmit path and the second latency of the receive path further using a measurement of the second latency of the receive path received from the second communication device via the communication link.

9. The network device of claim 1, wherein the latency compensation circuitry comprises:
a controller coupled to the transmit circuitry, the controller configured to cause the transmit circuitry to transmit the measured first latency of the transmit path to the second communication device to facilitate the second communication device using the measurement of the first latency to compensate for the asymmetry between the first latency of the transmit path and the second latency of the receive path.

10. A method for improving time synchronization in a communication network, the method comprising:
generating, at a first communication device, a measurement of a first latency of a transmit path of a communication link between the first communication device and a second communication device, the communication link also including a receive path; and
compensating, by the first communication device, for an asymmetry between the first latency of the transmit path and a second latency of the receive path using the measurement of the first latency.

11. The method for improving time synchronization of claim 10, wherein generating the measurement of the first latency of the transmit path comprises:
transmitting, by the first communication device, a probe signal via the transmit path to the second communication device;
receiving, at the first communication device, an echo of the probe signal via the transmit path; and
generating, at the first communication device, the measurement of the first latency based on the transmitting of the probe signal and the receiving of the echo.

12. The method for improving time synchronization of claim 11, wherein generating the measurement of the first latency of the transmit path further comprises:
measuring, with a counter, a delay between i) a first time at which the first communication device transmits the probe signal, and ii) a second time at which the first communication device detects the echo; and
determining, at the first communication device, the first latency using the delay.

13. The method for improving time synchronization of claim 10, wherein compensating for the asymmetry between the first latency of the transmit path and the second latency of the receive path comprises:
determining, at the first communication device, a compensation latency to add to a receive logical channel that includes the receive path using the measurement of the first latency; and
adding, at the first communication device, the compensation latency to the receive logical channel to compensate for the asymmetry between the first latency of the transmit path and the second latency of the receive path.

14. The method for improving time synchronization of claim 10, further comprising:
measuring, at the first communication device, a second latency corresponding to a transmit logical channel that includes the transmit path;
measuring, at the first communication device, a third latency corresponding to a receive logical channel that includes the receive path; and
compensating, by the first communication device, for an asymmetry between i) the second latency corresponding to the transmit logical channel and ii) the third latency corresponding to the receive logical channel.

15. The method for improving time synchronization of claim 14, wherein i) compensating for the asymmetry between the first latency of the transmit path and the second latency of the receive path, and ii) compensating for the asymmetry between the second latency corresponding to the transmit logical channel and the third latency corresponding to the receive logical channel, comprises:
determining, at the first communication device, a compensation latency to add to a receive logical channel that includes the receive path using i) the first latency, ii) the second latency, and iii) the third latency; and
adding, at the first communication device, the compensation latency to the receive logical channel to compensate for i) the asymmetry between the first latency of the transmit path and the second latency of the receive path, and ii) the asymmetry between the second latency corresponding to the transmit logical channel and the third latency corresponding to the receive logical channel.

16. The method for improving time synchronization of claim 10, further comprising:
receiving, at the first communication device, a measurement of the second latency of the receive path of the communication link from the second communication device;
wherein compensating for the asymmetry between the first latency of the transmit path and the second latency of the receive path comprises further using the measurement of the second latency received from the second communication device.

17. The method for improving time synchronization of claim 10, wherein compensating for the asymmetry between the first latency of the transmit path and the second latency of the receive path comprises:
transmitting, by the first communication device, the measured first latency of the transmit path to the second communication device to facilitate the second communication device using the measurement of the first latency to compensate for the asymmetry between the first latency of the transmit path and the second latency of the receive path.

18. A communication system, comprising:
a first network device coupled to a communication link, the first network device comprising first transmit circuitry coupled to a first path of the communication link and first receive circuitry coupled to a second path of the communication link; and
a second network device coupled to the communication link, the second network device comprising second transmit circuitry coupled to the second path of the communication link and second receive circuitry coupled to the first path of the communication link;
the first network device further comprising:
first latency measurement circuitry coupled to the first path, the first latency measurement circuitry configured to generate a measurement a first latency of the first path, and
first latency compensation circuitry communicatively coupled to one or both of the first transmit circuitry and the first receive circuitry, the first latency compensation circuitry configured to compensate for an asymmetry between the first latency of the first path and a second latency of the second path using the measurement of the first latency; and
the second network device further comprising:
second latency measurement circuitry coupled to the second path, the second latency measurement circuitry configured to generate a measurement of the second latency of the second path, and
second latency compensation circuitry communicatively coupled to one or both of the second transmit circuitry and the second receive circuitry, the second latency compensation circuitry configured to compensate for asymmetry between the first latency of the first path and the second latency of the second path using the measurement of the second latency.

19. The communication system of claim 18, wherein:
the first latency compensation circuitry comprises:
first signal generator circuitry coupled to the first path, the first signal generator circuitry configured to generate a first probe signal in the first path,
first echo detection circuitry coupled to the first path, the first echo detection circuitry configured to detect a first echo of the first probe signal in the first path, and
a first controller coupled to the first signal generator circuitry and the first echo detection circuitry, the first controller configured to generate the measurement of the first latency based on i) a generation of the first probe signal by the first signal generator circuitry and ii) a detection of the first echo by the first echo detection circuitry; and
the second latency compensation circuitry comprises:
second signal generator circuitry coupled to the second path, the second signal generator circuitry configured to generate a second probe signal in the second path,
second echo detection circuitry coupled to the second path, the second echo detection circuitry configured to detect a second echo of the second probe signal in the second path, and
a second controller coupled to the second signal generator circuitry and the second echo detection circuitry, the second controller configured to generate the measurement of the second latency based on i) a generation of the second probe signal by the second signal generator circuitry and ii) a detection of the second echo by the second echo detection circuitry.

20. The communication system of claim 19, wherein:
the first controller comprises a first counter, and wherein the first controller is configured to:
measure, with the first counter, a first delay between i) a first time at which the first signal generator circuitry generates the first probe signal in the first path, and ii) a second time at which the first echo detection circuitry detects the first echo in the first path, and
determine the measurement of the first latency using the first delay; and
the second controller comprises a second counter, and wherein the second controller is configured to:
measure, with the second counter, a second delay between i) a third time at which the second signal generator circuitry generates the second probe signal in the second path, and ii) a fourth time at which the second echo detection circuitry detects the second echo in the second path, and
determine the measurement of the second latency using the second delay.

21. The communication system of claim 18, wherein:
the first latency compensation circuitry comprises:
first configurable delay circuitry coupled to a first logical channel that includes the second path, the first configurable delay circuitry configured to add a first configurable amount of delay in the first logical channel, and
first latency compensation calculation circuitry configured to determine, using the measurement of the first latency, the first configurable amount of delay to be added by the first configurable delay circuitry; and
the second latency compensation circuitry comprises:
second configurable delay circuitry coupled to a second logical channel that includes the first path, the second configurable delay circuitry configured to add a second configurable amount of delay in the second logical channel, and
second latency compensation calculation circuitry configured to determine, using the measurement of the second latency, the second configurable amount of delay to be added by the second configurable delay circuitry.
